(19) United States
(12) Patent Application Publication
(10) Pub. No.: US 2024/0409861 A1
(43) Pub. Date: Dec. 12, 2024

(54) METHOD FOR DEALCOHOLIZATION OF A WINE

(71) Applicant: M H C S, Epernay (FR)

(72) Inventors: François LITOUX-DESRUES, Gradignan (FR); Robert LEARMONTH, Spring Gully (AU)

(73) Assignee: M H C S, Epernay (FR)

(21) Appl. No.: 18/690,366

(22) PCT Filed: Sep. 9, 2022
(86) PCT No.: PCT/FR2022/051704

§ 371 Date: Mar. 8, 2024

(30) Foreign Application Priority Data
Sep. 10, 2021 (FR) FR2109534

(51) Int. Cl. C12H 3/04; B01D 61/02

(52) U.S. Cl. CPC C12H 3/04; B01D 61/025; B01D 2315/16

(57) ABSTRACT

Method for dealcoholization of a volume V1 of a wine having a percentage of alcohol by volume (ABV) of ABV value (1), comprising: a) separating the volume V1 of the wine into two fractions: one fraction concentrated by a factor k/“retentate”, the volume of this fraction being equal to 1/k V1, this fraction having an ABV value (R); one fraction “permeate” comprising predominantly water and ethanol, the volume of this fraction being equal to (k−1)/k V1, this fraction having an ABV value (P); b) removing ethanol from the permeate, c) optionally, diafiltration of the retentate to obtain a “diafiltered retentate” and a “diafiltered metabolized permeate,” said diafiltered metabolized permeate then being optionally subjected to step (b) again; d) combining a volume of retentate, optionally diafiltered retentate, and a volume of metabolized permeate, to obtain a volume V2 of dealcoholized wine, having an ABV value (2) lower than ABV (1).

### FIELD OF THE INVENTION

The present invention relates to a method enabling the quantity of alcohol present in a wine to be reduced, without significantly modifying the organoleptic properties of said wine, that are responsible for its gustatory qualities.

### PRIOR ART

For nearly a century, it has been sought to lower the alcohol content of certain alcoholic beverages, in particular beer and more recently wine, or even to totally remove the alcohol from these beverages.

For multiple reasons, it may be desirable to lower the level of alcohol of certain alcoholic beverages. One of the main reasons relates to public health recommendations to limit alcohol consumption. In addition, recent increasingly followed trends in consumption are directed towards responsible consumption allowing the combination of conviviality and pleasure. Finally, due to global warming, grapes harvested at maturity have an increasing sugar content, and hence their fermentation leads to wines having significantly increased alcohol contents.

For several years, more and more traditionally produced alcoholic beverages have seen the appearance of an “equivalent” having a lower alcohol content or containing zero or almost zero alcohol, thus constituting a new product sector. Obtaining such an equivalent is a technical challenge, all the more so since the objective is to significantly lower the alcohol level and to offer the highest possible quality of gustatory experience during tasting.

Several strategies are known from the prior art for obtaining beverages with a low-alcohol content, or even with a zero-alcohol content.

There are two main strategies:
One consists in limiting the production of alcohol before or during the fermentation phase, by acting either on the raw materials used or on the progress of the fermentation, using yeasts that produce little alcohol.
The other strategy involves acting on the alcoholic beverage once its production process has been completed (“post-fermentation approach”), in order to reduce its alcohol content by transforming or extracting the alcohol present in this so-called “finished” beverage.

Several methods have been employed for implementing the first strategy. In particular, for a wine, when the alcohol is produced gradually in the must through consumption by the yeast of the sugar coming from the grape, it is possible to act at several levels at this stage in the fermentation in order to reduce the alcohol production. Several examples are described, in particular, in the following documents:
the patent FR2852493 describes a method for partial reduction of the sugar content of juices;
the patent FR2887258 describes the use of genetically modified yeasts for producing less alcohol;
the international application WO 2015/114115 relates to the use of yeasts that are stressed beforehand, in order to produce less alcohol;
the U.S. Pat. No. 5,266,337 from Barwäld et al. proposes a method in which the yield from the alcohol fermentation process is reduced during the anaerobic phase of ethanol production, then the ethanol content is reduced during a second step of the same fermentation, but under aerobic conditions;
the article (Morales et al., 2015) describes a method for fermenting a grape must, enabling the final alcohol content to be reduced, based on the use of a mixed culture of yeasts and control of the level of oxygenation. It has been shown that the greater the reduction in the percentage of alcohol, the greater the production of acid, in particular acetic acid.

Therefore, this method does not enable a significant reduction in the percentage of alcohol to be obtained while conserving the gustatory properties of the wine.

The second strategy, referred to as post-fermentation, uses a collection of methods, such as:
(i) separation methods, in particular membrane methods,
(ii) thermal methods, such as vacuum distillation or spinning cone columns,
(iii) microbiological methods, or
(iv) a combination of these methods.

The separation methods include the technique consisting in using a compound having an affinity for ethanol, such as an enzyme, immobilised on a column: during the passage of the alcoholic beverage over said column, the ethanol is immobilised and/or transformed by said enzyme. This technique is described in international application WO 90/01537. The implementation of this technique requires the use of a column, which according to the applicant is not a commonly used device in the industry for the production of alcoholic beverages on the industrial scale, and in particular in the wine industry. Moreover, this technique leads to an accumulation of acetaldehyde which is detrimental to the gustatory quality of the wine. This acetaldehyde will then be removed in a second step using unspecified methods, which do not allow the organic properties of the final dealcoholised wine to be conserved.

Membrane separation techniques include, in particular, membrane contractors, ultrafiltration, nanofiltration and reverse osmosis, which are well known to a person skilled in the art and have been used for many years for this purpose, in order to correct the alcohol content by several degrees, most often for regulatory reasons.

Reverse osmosis is the most used technique for reducing the alcohol content of a wine, because it can be carried out at low temperature, which enables better conservation of the taste of the wine (Pickering, 2000).

Diafiltration, which is another membrane technique, is in turn well known to beer brewers. It is used in order to reduce the alcohol content more strongly, in a very different context to that of wine, in particular on the regulatory level. This technique, often followed by dilution, requires the intake of exogenous water, in a quantity that increases the more the desired reduction in the alcohol content, and the loss of endogenous water. More specifically, it aims to replace the extracted volume of alcohol by exogenous water, which can significantly reduce the alcohol content until it is less than or equal to 0.5 vol. %.

It is therefore possible to produce a beer having an alcohol content less than or equal to 0.5 vol. %, but with a quality that often leaves something to be desired, especially since the methods employed enable only a weakly flavoured beer to be obtained after removal of the alcohol. Consequently, it is necessary to re-flavour it using exogenous flavouring.

Moreover, this technique intrinsically generates a large volume of waste.

In the wine industry, the use of exogenous water as an input for dealcoholisation is generally avoided, which makes it more complicated to obtain an alcohol content less than 0.5 vol. %, which is required for a so-called “alcohol-free” wine according to the applicable legislation of the International Organisation of Vine and Wine (OIV).

In the wine industry, it is desirable to have available a dealcoholisation technique which uses no exogenous compounds that could be considered a “dealcoholisation input”, including when it is desired to obtain a low or zero alcohol content.

With the exception of diafiltration, the various techniques described above do not, by themselves, enable the alcohol content of wines to be significantly reduced (by more than 2 vol. %), while conserving their organoleptic properties (Varela, 2015).

This is why various combinations of these techniques have been used in order to try to obtain these quality and yield objectives, in particular separation and thermal techniques, until now without success.

For example, the patent US 2016/0326473 describes a method for dealcoholisation of wine, in which a first separation step can separate a “retentate” comprising the compounds of interest, and a “permeate” which undergoes a distillation in order to remove the alcohol concentrated in this fraction.

The so-called “microbiological” methods, when they are applied to the finished alcoholic beverage, are based on metabolising ethanol into water and CO₂ under aerobic conditions, by yeasts capable of performing this biochemical transformation.

These methods involve directing the metabolism of the yeasts towards the consumption of a part of the alcohol produced. This directing of a fermentation metabolism (more precisely termed “respiro-fermentation” consisting in the consumption of sugars and the production of ethanol and CO₂, in the presence or absence of oxygen) towards a respiratory metabolism (consumption of alcohol in the presence of oxygen only) is called a “diauxic transition”

Thus, Bärwald and Fischer (1996) and Rodrigues et al. (2016) have both mentioned the possibility of operating this diauxic transition in situ, starting from a fermentation phase on must, and “pushing” respiration beyond the total exhaustion of sugars, then continuing it by consumption of ethanol. This technology has the disadvantages of altering the aromatic bouquet through the oxidation of aromas and the synthesis of acetaldehyde.

European patent application EP3550007 relates to a method for dealcoholisation of an alcoholic beverage, comprising the addition of a non-Saccharomyces yeast to said beverage, and the fermentation of this beverage under limited oxygen conditions, in order to reduce the alcohol content present. The examples presented relate to dealcoholisation of fermented products, comprising 5 vol. % ethanol. This technical teaching concerns a method suitable for the dealcoholisation of beer, with initially low percentage of alcohol by volume (ABV) and less susceptible to changes in terms of organoleptic properties than a wine.

Hence, these microbiological methods, described in the prior art, only appear to be applicable in the case of alcoholic beverages having an initial relatively low alcohol content (4 vol. % in Bärwald and Fischer (1996), 5 vol. % in Rodrigues et al. (2016) and in EP3550007) and in an environment that is relatively rich in nutrients for the yeasts, such as a grape must or a beer.

This microbiological technique generally has the following disadvantages:
risk of generating oxidation of the flavours due to the presence of oxygen,
risk of consumption of the compounds responsible for flavours and other carbon compounds of interest such as glycerol or lactic acid for a wine, by the yeasts, as preferred substrate, in place of ethanol, said compounds of interest having an important role which mainly gives the beverage concerned its organoleptic properties,
production of compounds that are undesired because they are synonymous with taste defects, in particular acetaldehyde, by the yeasts.

Hence, the implementation of this type of microbiological method inevitably leads to a degradation of certain compounds of interest, modifying the organoleptic properties of the alcoholic beverage.

These compounds are termed of interest because they mainly confer the organoleptic properties of said beverage, synonymous with quality, both in terms of mouth-feel sensations (structure compounds) as well as those linked to the bouquet (flavour compounds).

This is another reason why the various combinations of these separation, thermal and/or microbiological techniques have also been implemented, in order to try to attain these quality and yield objectives, again without success.

It has been proposed, for example in international application WO 2011/088809, to combine a physical separation method with a microbiological method.

In this process, the physical method consists of freezing the alcoholic beverage, then subtracting the alcoholic phase which has remained liquid, which corresponds to dilution by subtraction. The subsequently thawed frozen portion of the beverage again contains alcohol, but at a low level; it is therefore possible to perform a transformation of the remaining ethanol by adding a Candida yeast. However, this technique has many disadvantages: loss of compounds of interest dissolved in the alcoholic phase, oxidation of said compounds of interest in the phase subjected to the action of yeasts, and consumption of glycerol by the yeasts.

Hence, among the many existing techniques, none, including when they are combined with one another, enables a significant reduction in the initial alcohol content of the beverage to be achieved in the absence of exogenous water and/or techniques that are often too invasive, in particular when it is necessary to implement them a large number of times, and to limit the negative impact of these techniques on the compounds of interest present in said beverage in a manner appropriate for finally arriving at a product with the highest possible quality and as faithful as possible to the intrinsic properties of the original product.

There is therefore a real need to have a method implementing techniques enabling a very low or zero alcohol content to be attained while preserving such compounds of interest for the highest quality result possible in terms of taste.

This preserving of the gustatory quality of beverages, in particular wines, is often the most difficult technical problem to solve when developing methods for dealcoholisation, because the compounds of interest, in particular the flavour compounds, are either removed with the alcohol, or degraded by the application of a method including at least one heating or oxidation step.

Another disadvantage of the technologies presented above is that the majority usually require a subsequent addition of additives once the above-mentioned dealcoholisation techniques have been implemented, in order to mask certain undesirable tastes, and/or in some cases, in order to flavour the dealcoholised beverage thus obtained.

Hence, to date, the dealcoholised beverages, in particular wines, available on the market often have the disadvantage of presenting flavour notes of vegetable, plastic, cooked fruits or jam. Some have the characteristic notes of artificial flavours (peach, apricots, strawberry, etc.). The mouth feels are often built on sugar, to the detriment of finesse and balance. In general, these tastes are rejected by the consumer because they are unusual or are absent in their alcoholic equivalents, either because they result from the dealcoholisation techniques used (oxidation, heat, strong dilution), or because artificial flavours have been added. These tastes are often not appreciated by consumers seeking quality products.

There is therefore a need for a technical solution for dealcoholisation that is more respectful of the wine to be dealcoholised, enabling a low or zero alcohol content to be attained while preserving as much as possible the compounds of interest of the initial wine in order to be able to obtain a quality dealcoholised wine, capable of responding to the expectations of consumers seeking gustatory pleasure.

There is also a need for a technical solution that is even more exacting in terms of specification, like those provided for the protected designations of origin (PDO/AOP), limiting or prohibiting the use of external dealcoholisation inputs to the original wine, such as exogenous water, in order to be as faithful as possible to the typicality and intrinsic characteristics of the initial wine.

Finally there is a need for a method that is more natural and environmentally friendly, in particular by reducing waste generated by the wine industry. During the implementation of the dealcoholisation methods described above, the repeated use of exogenous water generates very large quantities of liquid by-products that are unusable and/or not recyclable, which are therefore thrown away. However, current recommendations are to limit the quantity of waste generated, in particular the quantity of liquid waste. It is also desirable to limit the use of additional devices, the manufacturer of which would require a specific method.

### BRIEF DISCLOSURE OF THE INVENTION

The present invention relates to a method for partial or total dealcoholisation of a wine, making it possible to obtain a dealcoholised wine in which the compounds of interest (in particular the flavour compounds) initially present are not only conserved but also preserved (not denatured), in particular by oxidation, and optionally an excessive temperature linked to a heating step. These compounds are first isolated in an appropriate manner, and the techniques implemented to remove the alcohol present are those most respectful of these compounds. These compounds of interest thus remain present in the partially or totally dealcoholised wine.

This method is based on the combination of a physical membrane separation step and a microbiological step applied to one of the fractions obtained during said first physical separation step.

The membrane separation method enables the following two fractions to be separated:
i. a concentrated fraction referred to as “retentate” comprising all the compounds of interest of the wine, namely water, alcohol, glycerol, organic acids, sugars, polyphenols and flavour compounds; and
ii. a fraction referred to as “permeate” mainly comprising water and ethanol. These compounds of interest are thus first isolated in an appropriate manner, and the techniques implemented in order to remove the alcohol present in the two phases are respectful of said compounds. These compounds of interest are thus preserved in the partially or totally dealcoholised or wine.

More precisely, the present invention relates to a method for dealcoholisation of a volume V1 of wine having a percentage of alcohol by volume (ABV) of value ABV(1), comprising the implementation of the following steps:
a) separating the volume V1 of the wine into two fractions using a membrane separation method:
   one fraction concentrated by a factor k referred to as “retentate”, the volume of this fraction being equal to 1/k V1, this fraction having a value ABV(R);
   one fraction referred to as “permeate” mainly comprising water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the fraction thus obtained being referred to as “metabolised permeate” and having a value ABV(P metabolised) less than ABV(P);
c) optionally, diafiltrating the retentate with the metabolised permeate, in order to obtain:
   a “diafiltered retentate” having a value ABV(R diafiltered) less than ABV(R), and
   a “diafiltered metabolised permeate” having an ABV value greater than ABV(P metabolised), said diafiltered metabolised permeate then being optionally subjected again to step (b);
d) combining a volume of retentate or diafiltered retentate and a volume of metabolised permeate, in order to obtain a volume V2 of dealcoholised wine, having a value ABV(2) less than ABV(1).

The microbiological step (b) is based on the addition of yeasts into the permeate, said yeasts being capable of metabolising ethanol by respiration, under limited aerobic conditions, in other words in the presence of low quantities of oxygen.

Advantageously, this step can transform all or part of ethanol present in the permeate, without having recourse to separation and/or thermal techniques with the many above-stated disadvantages.

Advantageously, this microbiological step does not produce any waste, apart from carbon dioxide and the biomass of the yeasts, these being able to be subsequently recycled. For example, the carbon dioxide produced can be collected and reused subsequently, in particular for (re)carbonation of beverages, in particular wines that have been dealcoholised beforehand.

This dealcoholisation method can be considered as a “quality method”, provided it enables the compounds of interest and, most particularly, the flavours of the initial wine to be preserved, and thus enables a dealcoholised wine to be obtained having a satisfactory taste, which does not require the addition of artificial flavours or taste enhancers.

At the end of the implementation of the method according to the invention, the organoleptic profile of the dealcoholised wine is close to that of the initial wine, as is its flavour profile.

Advantageously, the method of the invention can significantly reduce the percentage of alcohol by volume (ABV) of a wine without needing to multiply the steps with the many known disadvantages of separation and/or thermal techniques, which are long, onerous and prejudicial to the gustatory quality of the dealcoholised wine, in particular if repeated too many times.

Particularly advantageously, the method of the invention can be implemented without any use and/or without any addition of compounds exogenous to the wine to be dealcoholized, as dealcoholisation inputs. Said dealcoholised wine only contains compounds initially present in the initial wine to be dealcoholised. Hence, the dealcoholisation method implemented is compatible with the highest quality requirements, in terms of those for specifications such as “Protected designation of origin” (PDO/AOP) or “Appellation d' Origine Contrôlée” (AOC), in which a given batch of grapes is transformed into wine which can be dealcoholised without recourse to any dealcoholisation input, thus preserving its typicality.

The method of the invention is also advantageously a multi-purpose and industrialisable method, capable of being adapted to different typologies of wines to be dealcoholised.

Another advantage of the method of the invention is that it generates little or no waste. More specifically, all the fractions coming from the wine intended to be dealcoholised can be used during the method of the invention, it being understood that the optimisation of the method comprises the use of its own diafiltration agent.

An additional advantage of the method of the invention is that its implementation does not require the specific manufacture (and thus the acquisition and associated costs) of new devices specifically for dealcoholisation, instead it uses equipment known to a person skilled in the art that is already widely used in the biomass fermentation, alcoholic beverage and wine industries in particular.

This method can therefore be qualified as a sustainable or “green” method, because it is respectful of nature.

The present application describes the first quality dealcoholisation method enabling: adjusting of the final ABV of the wine as desired (low alcohol content, in all cases with an ABV lower by at least 0.5 vol. % than the initial ABV—or an almost zero ABV, less than 0.5 vol. %) and/or adapting to the properties of the initial wine (ABV, typicality, etc.) using technical means compatible with varied production methods (for example in batch or fed-batch mode).

The present invention also relates to a metabolised permeate that can be obtained by the implementation of steps (a) and (b) of the method as described above.

This metabolised permeate is a new product which corresponds to a fraction obtained from a wine, mainly comprising water and ethanol, in which the ethanol has been partially or totally consumed by yeasts, under aerobic conditions.

This metabolised permeate can be used in the implementation of at least three steps of the method of the invention:
during optional step (a′), for lowering the ABV of the permeate, before undergoing step (b);
during optional step (c), as a diafiltration agent for lowering the ABV of the retentate;
during step (d), for obtaining a dealcoholised wine, by combination with a volume of retentate.

### DESCRIPTION OF THE FIGURES

Other features, aims and advantages of the invention will emerge from the following description, which is given purely by way of illustration and not being limiting and which should be read with reference to the attached drawings, according to which:

FIG. 1 schematically illustrates the essential steps of the method of the invention, for obtaining a partially dealcoholised wine. Steps (a), (b) and (d) are shown schematically.

FIG. 2 schematically illustrates the essential steps of the method of the invention, for obtaining a totally dealcoholised wine. Steps (a), (b), (c) and (d) are shown schematically.

FIG. 3 illustrates a piece of reverse osmosis equipment, comprising a feed platform (19), reverse osmosis platform (20) and a permeate tank (18).

The feed platform (19) comprises 500-litre pallet tank (1) comprising a controlled solenoid valve (2), a nitrogen regulator (3), a pressure sensor (4) and an oxygen probe (5). It also comprises temperature sensors (6), a plate heat exchanger (7), a circulation pump (8), three-way valve (9), a centrifugal pump (10), a mass flow meter (11), a strainer (12), an application programming interface (API) (13) and a human-machine interface (HMI) (14).

The reverse osmosis platform (20) comprises a positive displacement pump (15), a membrane (16) and a pressure valve (17). It is connected to the permeate tank (18) by a pipe controlled by a flow meter.

FIGS. 4a and 4b illustrate step (b3) of metabolising ethanol present in a permeate with ABV of approximately 6 vol. %, after dilution.

FIG. 4a illustrates step (b3) of metabolising, in batch mode, the ethanol present in a permeate having an ABV of approximately 6 vol. % (the exact ABVs are indicated in the figure), as a function of incubation time with the yeasts, expressed in days. The ABV of 6 vol. % was obtained by dilution of a permeate with higher ABV.

The yeasts strains used are strains of Saccharomyces cerevisiae:
Vitilevure DV10®, selected by the “Comité interprofessionnel du vin de Champagne (CIVC) and marketed by Danstar, known for being used in the vinification of a champagne, or more generally for sparkling wines vinified according to the “Champagne method”;
Lalbrew® Abbaye, marketed by Lallemand and used for the brewing of beers,
IOC Harmonie®, selected by the University of California, Davis under the name “Davis 522”, marketed by the Institut CEnologique de Champagne (IOC) as well as many companies worldwide, known as being a robust strain, used for the vinification of white, rose or red wine.

The graph shows:
two examples with strain DV10 (dots and solid line, starting at 6.10 vol. %; plus signs and dashed lines, starting at 6.27 vol. %),
an example with the strain Abbaye (squares and lines with large dashes, starting at 6.44 vol. %), and
an example with the strain Harmonie (diamonds and line with small and large dashes, starting at 6.11% vol.)

FIG. 4b illustrates step (b3) of metabolism in batch mode (black circles and dotted line, starting at 6.22 vol. %) and in fed-batch mode (black diamonds and solid line, starting at 6.45 vol. %), of ethanol present in a permeate, as a function of incubation time with the yeasts, expressed in days. The ABV of approximately 6 vol. % was obtained by diluting a permeate of higher ABV. The strain of yeasts used is a strain of Saccharomyces cerevisiae (Vitilevure DV10®).

FIG. 4c illustrates step (b3) of metabolism, in batch mode, of ethanol present in a permeate from a dry white wine as a function of incubation time with the yeasts, expressed in days. It involves a permeate with approximately 10 vol. % alcohol, from a separation reverse osmosis of a white wine, then diluted by the addition of spring water (brand: Cristaline).

The two strains used are non-Saccharomyces species, Lachancea thermotolerans (dots and solid line, starting at 6.23 vol. % ethanol), and Torulaspora delbrueckii (plus signs and dotted line, starting at 1.74 vol. % ethanol).

FIG. 5 illustrates step (b3) of metabolisation of ethanol present in two types of permeate (with ABV=2.5 vol. % or 5 vol. %) by three different strains of yeasts of the species Saccharomyces cerevisiae. These strains are indigenous to Champagne wine production, used in the vinification of Champagne, or more generally sparkling wines vinified according to the Champagne method:
Vitilevure DV10®, described above;
IOC18-2007, selected and marketed by the Institut CEnologique de Champagne; and
Levuline CHP®, selected by the CIVC and marketed by Danstar.

The graph shows the strains DV10 (black circles and solid line), CHP (plus signs and with larger dashes) and IOC18-2007 (crosses and dotted line).

FIG. 6 illustrates step (b3) of metabolisation, in batch mode, of ethanol present in a permeate from a dry white wine having an ABV of approximately 6 vol. % (the exact ABVs are indicated in the figure), as a function of incubation time with the yeasts, expressed in days. The ABV of approximately 6 vol. % was obtained by diluting a permeate of higher ABV with a permeate of 0 vol. % from a previous dealcoholisation cycle.

The strains of yeasts used are strains of Saccharomyces cerevisiae Zyamaflore Delta® (dots and solid line), the strain EC-1118 (plus signs and dotted line) Lalvin ICV D80 (squares and line with larger dashes), the strain ICVK1 (diamonds and line with smaller and larger dashes) and strain IOC Prestige (triangles with a sequence of two small and one large dash).

FIG. 7 illustrates step (b3) of metabolisation, in batch mode, of ethanol present in permeates from white wine, rosé wine, red wine from maceration, and red wine from thermovinification, having an ABV of approximately 6.25 vol. %, as a function of the incubation time with the yeasts, expressed in days.

The ABV of approximately 6.25 vol. % was obtained from a permeate with approximately 10 vol. % alcohol diluted with the addition of permeate 0 vol. % from a previous dealcoholisation cycle.

The yeast strains used are Champagne strains of Saccharomyces cerevisiae: Vitilevure® DV10 (upper panel) and the strain IOC 18-2007 (lower panel). The various permeates treated are: the permeate from white wine (dots and solid line), the permeate from rose wine (plus signs and dotted line), the permeate from wine by maceration (squares and line with larger dashes), and the permeate from red wine by thermovinification (diamonds and line with small and large dashes).

FIGS. 8A, 8B and 8C illustrate the properties of a white wine (Wine 0-029) dealcoholised according to the method of the invention, represented by a solid line; in comparison with the initial wine, not subjected to the method, represented by dashes.

8A) Graphic illustrating the profile of sugars, organic acids and alcohols of the studied beverages. Except for the quantity of alcohol expressed in %, the other concentrations are expressed in g/L.

8B) Graphic illustrating the profile of mineral elements (Na, Mg, Al, Ca, etc.) of the studied beverages. The concentrations are expressed in μg/kg.

8C) Graphic illustrating the flavour profile of the studied beverages.

The FIGS. 9A, 9B and 9C illustrate the properties of a rose wine dealcoholised according to the method of the invention, by comparison with the initial wine that has not undergone the method.

9A) Graphic illustrating the profile of sugars, organic acids and alcohols of the studied beverages. Except for the quantity of alcohol expressed in %, the other concentrations are expressed in g/L.

9B) Graphic illustrating the profile of mineral elements (Na, Mg, Al, Ca, etc.) of the studied beverages. The concentrations are expressed in μg/kg.

9C) Graphic illustrating the flavour profile of the studied beverages.

### DETAILED DESCRIPTION OF THE INVENTION

### Definitions

In order to understand the invention better, the terms used in the present application are defined below.

In the present application, the term “alcohol” designates ethanol with semi-structural chemical formula CH₃—CH₂—OH, having CAS number 64-17-5.

The term “wine” designates an alcoholic beverage, in other words containing alcohol, obtained by the fermentation of fresh grapes or grape must obtained by pressing. The preparation of the wine includes a “vinification” step, during which the grape must undergo an alcoholic fermentation due to the presence of yeasts, which transform the sugar of the grape into alcohol and carbon dioxide. The following preparation steps are ageing of the wine, blending and then bottling.

This term “wine” includes still wines and sparkling wines, in other words non-effervescent wines and effervescent wines.

Still wines include, in particular, red wines, white wines and rose wines, with or without residual sugars, the wines without residual sugar being designated “dry wines” and the wines with residual sugars being designated “sweet wines” or “syrupy wines”, depending on their sugar content.

Sparkling wines include, in particular, Champagne (according to the “Champagne” Appellation d'Origine Contrôlée) and wines obtained according to the Champagne method (through a second fermentation in the bottle) as well as wines carbonated in tanks.

In the context of a sparkling wine, the term “base wine” is understood to be a non-effervescent wine, in which the fermentation method is ended, which would be suitable for consumption. This “base wine” can be transformed into sparkling wine in two different ways through a carbonation step: either by the artificial addition of CO2 to the base wine or by the addition of products (sugars, yeasts, fermentation additives) necessary for the production of CO2 in the base wine during a second fermentation, said fermentation producing CO2 in order to make the base wine effervescent.

Within the meaning of the invention, percentage of alcohol by volume (ABV), also called the alcohol degree, shall mean the proportion of alcohol in a wine. This is the value obtained by performing the following division: volume of ethanol/total volume of the wine, these volumes both being measured at a temperature of 20° C., in accordance with the Compendium of International Methods of Analysis produced by the OIV.

In the present application, all the ABV are expressed as percentage by volume of alcohol (vol. %).

In order to determine the ABV of an alcoholic beverage, the ethanol present in the beverage is separated by distillation, then the density of the distillate is measured in order to determine the volume of pure alcohol extracted, given that the relative density of ethanol at 20° C. (0.789) is different from that of water (1 by definition).

There are also calibrated measuring instruments, used by professionals to measure the alcoholic content of beverages, without going through a distillation step: these include, in particular, electronic density meters.

Advantageously, the ABV is measured by high-performance liquid chromatography (HPLC).

The term “wine” or “initial wine” shall mean a wine which is subjected to the method according to the invention.

Within the meaning of the invention, the term “method for dealcoholisation” shall mean a process enabling reduction of the ABV of the initial wine having a percentage of alcohol by volume (ABV) with value ABV(1). At the end of this method, a dealcoholised wine is obtained having a value ABV(2), strictly less than ABV(1).

This dealcoholisation can be partial or total.

In the case of a partial dealcoholisation, at the end of the implementation of the method, the dealcoholised wine has an ABV value reduced by at least 1 vol. % relative to the ABV value of the initial wine. Preferably, the ABV value of the dealcoholised wine will be less by at least 2 vol. %, or even by at least 3 vol. %, than the ABV value of the initial wine, after implementation of the invention.

In the case of a total dealcoholisation, the dealcoholised wine has an ABV value less than or equal to 0.5 vol. %, or even an ABV value equal to 0 vol. %, in other words a zero mass of ethanol. Indeed, according to the applicable legislation from the International Organisation of Vine and Wine (OIV), any wine having an ABV less than 0.5 vol. % is considered as being a non-alcoholic or totally dealcoholised wine.

Within the meaning of the invention, the term “ABV value equal to 0 vol. %” shall mean a value close to 0, in other words where only traces of alcohol are present in the product concerned. As is well known by a person skilled in the art, these traces will be of a negligible quantity, for example in a quantity less than or equal to 0.01 vol. %, which is close to the detection threshold of measurement instruments.

Within the meaning of the invention, the term “input” or “dealcoholisation input” shall mean any exogenous compound that can be added to the initial wine during the dealcoholisation method, which was not present in the initial wine and which is therefore considered as an “input”. This could be, for example, exogenous water added during a dilution step.

Within the meaning of the invention, the term “membrane” shall mean a selective barrier which reduces the transfer of one solute relative to another, usually of a solute relative to water. The membranes have a porous structure. They are composed of organic materials (polymers such as cellulose acetate, polysulfone, polyester, polypropylene) or inorganic materials (ZrO2, TiO2, alumina, ceramic). There are membranes suitable for each filtration method (nanofiltration, reverse osmosis) as is well known to a person skilled in the art.

The term “fraction” shall mean a sub-portion of the volume of the initial wine, obtained after step (a) of physical separation by a membrane.

The term “retentate” shall mean one of the two fractions obtained by membrane separation from the initial wine. This is the fraction which does not cross the membrane. This concentrated fraction comprises all the elements present in the initial wine, and in particular water, ethanol, glycerol, organic acids, sugars and flavour compounds. This “retentate” fraction comprises, in particular, the flavour molecules responsible for the gustatory quality of the wine.

The term “permeate” shall mean the second fraction obtained by membrane separation from the volume of initial wine. This is the fraction which crosses the membrane: it is not concentrated and is mostly composed of water and ethanol.

Within the meaning of the invention, a “fraction mostly composed of” is understood as being a fraction consisting of at least 90% by mass of the cited compounds. In other words, in this fraction, the minority compounds are present in a proportion less than 10% cumulative mass of all the minority components, relative to the total mass.

### Detailed Disclosure of the Invention

The present invention relates to a method for dealcoholisation of a volume V1 of wine having a percentage of alcohol by volume (ABV) with value ABV(1), comprising the implementation of the following steps:
a) separating the volume V1 of a wine into two fractions using a membrane separation method:
   one fraction concentrated by a factor k referred to as “retentate”, the volume of this fraction being equal to 1/k V1, this fraction having a value ABV(R);
   one fraction referred to as “permeate” mainly comprising water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the fraction thus obtained being referred to as “metabolised permeate” and having a value ABV(P metabolised) less than ABV(P);
c) optionally, diafiltrating the retentate with the metabolised permeate, in order to obtain:
   a “diafiltered retentate” having a value ABV(R diafiltered) less than ABV(R), and
   a “diafiltered metabolised permeate” having an ABV value greater than ABV(P metabolised), said diafiltered metabolised permeate then being optionally subjected again to step (b);
d) combining a volume of retentate or diafiltered retentate and a volume of metabolised permeate, in order to obtain a volume V2 of dealcoholised wine, having a value ABV(2) less than ABV(1).

During the method, each fraction obtained is characterised by a percentage of alcohol by volume (ABV) as defined above. This concentration is always expressed, in the present application, in % by volume of the alcohol present, relative to the total volume of the fraction concerned. The following abbreviations are used in the present description:
ABV(1): percentage of alcohol by volume of the initial wine of volume V1;
ABV(P): percentage of alcohol by volume of the permeate coming from step (a) of the method;
ABV(P metabolised): percentage of alcohol by volume of the permeate having been subjected to step (b) of the method;
ABV(R): percentage of alcohol by volume of the retentate coming from step (a) of the method;
ABV(R diafiltered): percentage of alcohol by volume of the retentate following its diafiltration in step (c);
ABV(2): percentage of alcohol by volume of the dealcoholised wine, obtained by combining a volume of retentate, optionally diafiltered, and a volume of metabolised permeate.

The three essential steps a, b and d will preferably be carried out in this successive order: a, b then d.

### Step (a) of Physical Separation by a Membrane

The first step of the method according to the invention is a step of physical separation of the volume V1 of initial wine, using a membrane, into two fractions:
i. one fraction concentrated by a factor k referred to as “retentate” comprising all the elements initially present in the wine, and in particular water, ethanol, glycerol, organic acids, sugars and flavour compounds, the volume of this fraction being equal to 1/k V1; and
ii. one fraction referred to as “permeate” mainly comprising water and ethanol, the volume of this fraction being equal to (k−1)/k V1, and its ABV having a value ABV(P).

### Physical Separation Using a Membrane

The membrane separation method used in this process is based on the use of permeable membranes. The membrane acts as a very specific filter which allows water to pass, while retaining certain dissolved solutes, as a function of its selectivity, which depends on the size of the pores and the diffusibility of the solutes within the membrane. There are several methods for enabling substances to penetrate the membrane. It can involve, for example, and application of pressure, maintaining a concentration gradient between the two sides of the membrane, or even the application of an electrical potential.

The different membrane separation techniques can be distinguished as microfiltration, ultrafiltration, nanofiltration and reverse osmosis (RO or hyperfiltration), in decreasing order of the size of the pores of the membranes used.

Various parameters are used to characterise the operation of these membrane technologies. In particular, the selectivity of the method is evaluated by the complementary parameters: “rejection rate” and “retention rate”.

The choice of membrane type depends on a large number of parameters, in particular its selectivity with respect to the compounds to be separated. Other properties, such as the density, risk of clogging, required cleaning and cost, also need to be taken into account. In the present method, the choice of membrane will be substantially based on its selectivity properties with respect to ethanol and glycerol.

The membrane used in the method according to the invention should ideally have the following property: it should be able to separate two fractions, with all of the ethanol in the permeate, and with all of the glycerol which would be retained in the retentate. Hence, the membrane would ideally have: (i) a rejection rate of 1 for glycerol and the other compounds of the wine to be dealcoholised, and (ii) a very low rejection rate, ideally zero, for ethanol. However, no membrane exists having both of these two properties together.

Nevertheless, using his general knowledge, a person skilled in the art will choose the most suitable membrane for implementing this step of physical separation into two fractions, depending on the one hand on the properties of the wine to be dealcoholised, and on the other hand on the quality desired for the final product.

In order to ensure an optimum quality of the dealcoholised wine obtained after implementing the method, it is preferable to choose a membrane having a rejection rate of glycerol close to or equal to 1, even if this means that the ethanol rejection rate is not as close to zero as would be desired. Membranes having a rejection rate of 1 for glycerol, generally have a rejection rate of around 0.33 for ethanol.

Further, in order to obtain a method for dealcoholisation having maximum efficiency, it is preferable to choose a membrane having a very low ethanol rejection rate, close to zero.

The physical membrane separation of step (a) can be carried out according to any of the membrane techniques that are well known to a person skilled in the art. In particular, it will be possible to carry out said physical separation of wine to be dealcoholised into two fractions, by nanofiltration or by reverse osmosis.

The selectivity of nanofiltration membranes is defined by a size of solutes that can be separated by the permeable membrane. These solutes have a molar mass between 200 and 1000 Daltons.

According to a preferred implementation of the invention, step (a) is carried out by reverse osmosis or by nanofiltration, preferably by reverse osmosis.

The selectivity of reverse osmosis membranes is also defined by their rejection rate for salts. For the implementation of the method according to the invention, preferably a membrane is used, having a very high rejection rate of salts.

According to a preferred implementation of the invention, the membrane used has a rejection rate for salts greater than 0.9 (i.e. a rejection rate of 90% for salts), preferably greater than 0.95, and most preferably greater than or equal to 0.97.

According to a preferred implementation, the membrane used in the method according to the invention is an organic membrane made of polypropylene.

Examples of commercially available reverse osmosis membranes, that are suitable for implementing the method according to the invention, are presented in the experimental part of the present application. The flow which will be applied to each membrane will be adapted according to the chosen membrane, in accordance with the conditions recommended by the membrane supplier.

The pressure of the osmosis unit will preferably be between 20 and 100 bars, and will be, in particular, equal to 50 bars.

A numerical example of physical separation of a wine using a membrane, by reverse osmosis, at a pressure of 50 bars and while concentrating the retentate by a factor of 8, is presented in Table 1 below.

TABLE 1

| Product or | | | | | | |
|---|---|---|---|---|---|---|
| fraction | Wine | | Permeate | | Retentate | |
| Volume | 8/8 | | 7/8 | | 1/8 | |
| Theoretical ABV of | 11.6 | vol. % | 9.3 | vol. % | 28 | vol. % |
| the fractions | | | | | | |
| Observed ABV of the | | | 9.7 | vol. % | 21 | vol. % |
| fractions (average | | | | | | |
| of 40 tests) | | | | | | |
| Concentration of | 91.5 | g/L | 76.5 | g/L | 165.7 | g/L |
| ethanol in each | | | | | | |
| fraction (g/L) | | | | | | |

In this example, it appears that 73% of the ethanol has flowed into the permeate, but that 27% of the ethanol has been retained by the membrane in the highly concentrated retentate.

Preferably, membrane separation step (a) is carried out at a temperature between 15° C. and 25° C., more preferably between 15° C. and 20° C., or even between 15° C. and 18° C.

Moreover, this step (a) will preferably be carried out under an atmosphere mainly composed of inert gas, and more precisely comprising less than 3% molecular oxygen, or better less than 2% molecular oxygen, or even less than 1% molecular oxygen.

Indeed, the presence of molecular oxygen in the atmosphere of the device used could be the cause of oxidation of the compounds of the wine. However, the compounds of interest of the wine, and in particular the flavour compounds of the wine, can be degraded by oxidation and it is therefore preferable to limit this phenomenon.

These particular conditions of temperature and atmosphere comprising a low proportion of molecular oxygen, make it possible to separate these two fractions while avoiding denaturation of the compounds of interest of the wine, which are concentrated in the retentate.

In general, in the prior art, a physical separation step is accompanied by heating of the device employed, and consequently of the treated wine. However, the rise in temperature is prejudicial to the quality of the compounds of the wine, in particular the compounds of interest such as the flavour compounds.

According to one implementation option, the method according to the invention does not comprise a heating step. The method can optionally comprise a cooling step, in order to control the increase in temperature observed during the membrane separation step.

### Properties of the Two Obtained Fractions

At the end of the physical separation step, the retentate is concentrated by a concentration factor k. Hence:
a) for a concentration factor k=2, the volume Vr of the retentate will be ½ of the volume V1 of the initial wine;
b) for a concentration factor k=8, the volume Vr of the retentate will be ⅛ of the volume V1 of the initial wine.

According to a particular implementation of the invention, the concentration factor k is between 0.1 and 20, preferably between 2 and 10, more preferably between 5 and 10.

In order for the method according to the invention to be efficient, it is not necessary that the concentration factor k is very high; hence, in the case where k is equal to 2, the method according to the invention can result in a dealcoholised wine with ABV equal to ⅔ of the ABV of the initial wine.

A person skilled in the art will be able to determine the relevant concentration factor k for implementation of the invention, in particular depending on the nature of the initial wine, its ABV, its osmotic pressure and its solute concentration.

For example, for the complete dealcoholisation of a wine with ABV of approximately 11 vol. %, the concentration factor k is advantageously equal to 8.

The permeate is mostly composed of water and ethanol. The term “mostly” designates the fact that less than 10%, or even less than 5%, or less than 4%, or preferably less than 3% by mass of minority compounds of the permeate are of a different nature than water or ethanol. The permeate can for example consist of:
c) 98% water and ethanol; and
d) 2% at most of other compounds, such as acids or other organic molecules of low molecular weight.

By way of example, the following composition by mass of permeate at approximately 9.3 vol. % has been observed: 925 g water, 73 g ethanol and 2 g of other compounds (i.e. 0.2% mass/mass) are measured in 1000 g of permeate.

The retentate consists of water, and contains all the other elements composing the wine, in particular the main compounds of interest: glycerol, organic acids (such as lactic acid, acetic acid, tartaric acid, malic acid, succinic acid), sugars (in particular fructose), polyphenols, flavour compounds (in particular esters, for example ethyl acetate), etc. These compounds are more concentrated than in the initial wine.

The retentate also comprises ethanol, the reverse osmosis operation does not enable complete separation of both compounds glycerol and ethanol, for the reasons previously described.

During the implementation of the following steps (b) and optionally (a′), the retentate obtained in step (a) is conserved, preferably at a temperature less than 10° C., before its subsequent use during steps (d) and optionally (c).

Step (a′) of Reducing the ABV(P) of the Permeate

According to a particular implementation of the invention, the permeate is subjected to at least one step (a′) for reducing its ABV(P).

Indeed, it can be advantageous to start step (b) on a permeate having a previously lowered ABV(P).

More specifically, it is known to a person skilled in the art that, at high concentration, ethanol can be toxic for yeasts, in particular for yeasts of the genus Saccharomyces.

Hence, it would not be possible to proceed to step (b) of the method according to the invention on a wine, for at least two main reasons:
The ABV of the wine would be too high (generally between 10 vol. % and 15 vol. %) in order to ensure the survival of yeasts intended for the metabolisation of ethanol;
The compounds of interest, in particular the flavour compounds, of the wine would be susceptible to being degraded by the action of said yeasts, generating a reduction in the flavour quality of the resulting dealcoholised wine.

As has been previously described, for a wine with ABV(1)=11.6 vol. %, if step (a) can separate a retentate and a permeate with ABV(P)=9.3 vol. %, such a concentration of ethanol could be too high for the yeasts to be effective, depending on the strain used.

The inventors have identified that, in order to limit the intoxication of yeasts by too high a concentration of ethanol, the value of ABV(P) is ideally less than or equal to 9 vol. % Following step (a), ABV(P) advantageously has a value less than or equal to 10 vol. %, or less than or equal to 9 vol. %, 8 vol. %, 7 vol. %, 6 vol. %, or even a value less than or equal to 5 vol. %.

A step (a′) of reducing ABV(P) before step (b) can therefore advantageously be carried out, and this by several techniques known to a person skilled in the art.

According to an implementation of the invention, the permeate is subjected to at least one step (a′) of reducing its ABV(P).

This step (a′) is preferably carried out by evaporation, distillation, dilution or membrane contractor.

According to first implementation, this step (a′) does not involve an exogenous addition of liquid, in other words no dealcoholisation input is used. In this case, the reduction of the value of ABV(P) is carried out by evaporation, dilution or membrane contractor, using the metabolised permeate as diluent, optionally filtered.

In particular, this step (a′) can be carried out by direct dilution or by membrane contractor using, as diluent, the metabolised permeate obtained during a preceding implementation of the method, in order to entrain the excess ethanol and thus lower the ABV(P) of the permeate before subjecting it to step (b).

Preferably, said metabolised permeate used as diluent has an ABV value less than or equal to 1 vol. %, or less than or equal to 0.5 vol. %, more preferably is equal to 0 vol. %.

According to a second implementation, this step (a′) is carried out by dilution or by membrane contractor with a dealcoholisation input, using exogenous water as diluent, for example mineral water.

By carrying out a step (a′) reducing the ABV of the permeate, the advantages of the two technologies are gained, membrane separation and metabolisation of ethanol by a microbiological method:
the effectiveness of the physical method for reducing the initial ABV is, for example, a reduction in the ABV value from 12 to 9 vol. %, and
the microbiological performance which enables total consumption of the ethanol by the yeasts and therefore, for example, the lowering of the ABV value from 9 vol. % to a lower value, ideally 0 vol. %.

### Step (b) of Partial Removal of the Ethanol Contained in the Permeate by Yeasts in Respiratory State

In step (b) of the method according to the invention, yeasts are added to the permeate of ABV(P), said yeasts being in respiratory state and thus being capable of metabolising the ethanol present in the permeate, by a biochemical respiration process.

Within the meaning of the invention, “yeasts in respiratory state” shall mean yeasts capable of transforming organic products in the presence of molecular oxygen in order to produce ATP.

This step (b) of ethanol metabolisation is carried out under aerobic conditions, in other words in the presence of dioxygen, more precisely in a liquid medium in the presence of dissolved dioxygen, provided by continuous equilibration with an atmosphere comprising dioxygen, or by a flow of gas continuously injected into the medium.

The removal of ethanol present in the permeate can be partial or total. In the case where the removal of ethanol is total, the metabolised permeate obtained will have an ABV value equal to 0 vol. %.

According to a particular implementation of the method, step (b) comprises three substeps:
b1) pre-culturing of at least 10⁶ yeasts per millilitre, in a growth medium comprising a source of sugar at a concentration between 40 and 120 g/kg, under aerobic conditions,
b2) culturing at least 10⁶ yeasts coming from step (b1) per millilitre, in a growth medium comprising a source of sugar at a concentration between 40 and 120 g/kg, under aerobic conditions, the volume of culture being identical to the volume of permeate to be treated in the following substep,
b3) adding at least 2·10⁸ yeasts per millilitre to the permeate to be treated, and metabolising of the ethanol by the yeasts under aerobic conditions.

The aim of both first phases (or substeps) is to generate biomass by multiplication of yeasts, as well as conditioning the yeasts; then phase b3 corresponds to the phase of metabolising the ethanol present in the permeate itself.

The quantities of yeasts indicated above correspond to the quantities of viable yeasts.

The permeate is a “hostile” environment for the growth of yeasts. More specifically, it contains very few nutrients (with the exception of ethanol), has a very low conductivity and a very acid pH (pH of approximately 3, for example pH=3.2). It is therefore preferable to create sufficient biomass of yeasts before adding them to the permeate so that they can carry out an effective transformation of the ethanol.

Through these pre-culture steps, the yeasts added to the permeate have good viability and good activity; moreover, they have stored important nutrients during this pre-culture, such as ions, nitrogen, vitamins and lipids.

Finally, the pre-culture conditions during phases (b1) and (b2) enable the yeasts to adjust their metabolism, passing through the diauxic transition from a sugar-based fermentation metabolism to an ethanol-based respiration metabolism.

As is well known to a person skilled in the art, between each phase b1, b2 and b3, the yeasts are harvested and rinsed and the container changed, if necessary.

This yeast pre-culture step will be carried out under the usual conditions that are well known to a person skilled in the art, such as under the following conditions:
at a temperature between 15° C. and 38° C., and
while stirring.

The growth media used during phases b1 and b2 are those well known to a person skilled in the art.

In particular, the growth medium for the yeasts comprises inositol, at a concentration between 2 and 200 mg/L, and preferably at a concentration between 20 and 50 mg/L of medium. The effects of various concentrations of inositol during culture of Saccharomyces cerevisiae yeasts have been reported, in particular, in the articles (Ishmayana et al., 2015) and (Ishmayana et al., 2020).

Advantageously, said growth medium can also comprise a source of nitrogen, in particular at a concentration between 300 and 400 mg/L, and of zinc, in particular at a concentration of 3 to 5 mg/L, and vitamins and ions according to the needs of the strain of yeast used.

For example, it is possible to use a “standard” microbiology medium such as “Sabouraud”, “Yeast Extract Peptone” or “Yeast Nitrogen Base”, with or without amino acids, or even an “oenological” medium such as Activit O (IOC), a grape must, or even a synthetic must as used by (Ochando et al. 2017). An example of a growth medium is presented in the experimental part.

Advantageously, the yeasts are cultivated in aseptic mode.

The growth medium used during phases (b1) and (b2) contains a source of sugar at a concentration between 40 and 120 g/kg, in particular at a concentration of 80 g/kg. This sugar source can be of several types, depending on the properties of the strain of yeasts used, such as for example glucose or sucrose or a mixture of several sugars.

According to a preferred implementation, the source of sugar consists exclusively of sucrose.

According to a particular implementation of the method, step (b1) lasts between 24 and 36 hours.

According to another particular implementation of the method, step (b2) lasts between 36 and 48 hours.

All these phases are carried out in the presence of oxygen, in other words under aerobic conditions.

The consumption of ethanol by the yeasts takes place under aerobic conditions; following the addition of the yeasts in the permeate, the mixture is subjected to a constant flow of oxygen, suitable for the implementation of said ethanol metabolisation, where the quantity of oxygen supplied is limited.

The oxygen flow rate used is adjusted according to the quantity of ethanol present, in order to correspond to the total quantity of oxygen calculated beforehand according to the following chemical equation:

CH₃—CH₂—OH+3O₂->2CO₂+3H₂O.

According to a particular implementation of the method of the invention, step (b3) of metabolisation of ethanol by yeasts is carried out under a flow of molecular oxygen between 0.001 and 0.010 volume per volume per minute (vvm), preferably between 0.002 and 0.008 vvm.

The conventional technique of aeration used for this step is carried out with an “air” mixture composed of molecular oxygen (O2) and nitrogen (N2), preferably comprising between 20 and 35% molecular oxygen, or more preferably between 28 and 34% molecular oxygen, in order to promote the respiratory metabolism of the yeasts.

For example, the aeration of the three phases b1, b2 and b3 can be carried out thus:
phase (b1): the yeasts are cultivated in Erlenmeyer flasks plugged with cotton wool, permeable to air;
phase (b2): the yeasts are cultivated in a fermenter, with an aeration as defined below: between 0.004 and 0.008 vvm molecular oxygen, supplied either by the addition of a mixture of oxygen and nitrogen, or by addition of compressed air;
phase (b3): the yeasts are cultivated in a fermenter, with an aeration as defined below: between 0.002 and 0.008 vvm molecular oxygen, supplied either by the addition of a mixture of oxygen and nitrogen, or by the addition of compressed air.

After partial or total metabolisation of the ethanol present in the permeate, the yeasts are removed from the mixture, by any technique known to a person skilled in the art, such as filtration or centrifugation, in order to obtain a fraction referred to as “metabolised permeate” with ABV(P metabolised) having a value less than that of the initial permeate, ABV(P).

This phase (b3) in the presence of yeasts can be of variable duration. Its duration will depend, in particular, on the initial ABV(P), the nature and quantity of yeasts added.

For example, in order to obtain a partial removal of the ethanol present in the permeate, a duration of 4 to 8 days would be sufficient for phase (b3); for complete dealcoholisation of a permeate with ABV(P) of approximately 6 vol. %, between 24 and 32 days will be necessary, depending on the strain of yeast used (see FIGS. 4a, 4b and 4c).

Table 5 in the experimental part presents steps (b3) having a duration of 21 to 35 days, and having enabled the obtaining of an ABV with a value less than 0.6 vol. % in all cases, and in almost all cases a value less than 0.2 vol. %.

During the performance of phase (b3), means known to a person skilled in the art will be used in order to monitor the metabolisation of the ethanol. For example, the weight reduction of the medium (permeate+yeasts) can be monitored over time: when the weight of the medium stabilises, this means that the ethanol metabolisation reaction is complete. Furthermore, the flow rate and the percentage of CO₂ can be monitored at the fermenter outlet, or by sampling and then assaying the ethanol.

This step (b3) will preferably be carried out over a duration sufficient that the ABV value of the metabolised permeate is less than or equal to 1 vol. %, more preferably is less than or equal to 0.5 vol. %, and most preferably is equal to 0 vol. %.

Hence, according to a particular implementation of the method, step (b3) is implemented until the alcohol of the permeate is completely consumed, in other words until the ABV value (P metabolised) is less than 0.8 vol. %, 0.7 vol. %, 0.6 vol. %, 0.5 vol. %, 0.4 vol. %, 0.3 vol. %, 0.2 vol. % or less than 0.1 vol. %, or even equal to 0 vol. %.

As previously indicated, the permeate contains most of the water and ethanol; hence, the organic substrate available for the yeasts is mostly ethanol.

The method according to the invention advantageously makes it possible (i) to conserve, over the course of the method, the organic molecules of interest other than ethanol, for example glycerol and lactic acid, by performing a first step of physical separation of ethanol and glycerol, and thus only offering the yeasts ethanol to consume; and (ii) to promote the consumption of ethanol by the yeasts due to the fact that this organic substrate is the majority substrate in the permeate.

It is intended that any type of yeasts capable of metabolising ethanol under aerobic conditions can be used for implementing step (b) of the claimed method. A person skilled in the art will know to choose the species of yeasts and their culture conditions (temperature, quantity of yeasts, culture medium, etc.) in order to optimise this consumption of the ethanol present in the permeate.

Several types of yeasts capable of consuming ethanol under aerobic conditions are known; by analysing the metabolic properties of 439 species of yeasts, Barnett et al. (1990) have identified 334 species capable of reproducing and growing in the presence of ethanol as the only source of carbon. Among these, 250 species have normal growth, neither slowed nor variable, in particular the species Saccharomyces cerevisiae, but also Saccharomyces dairensis, Saccharomyces exiguus, Saccharomyces kluyveri, Saccharomyces telluris, and Saccharomyces unisporus.

According to an implementation of the invention, the yeasts added to the permeate during step (b) are of the genus Saccharomyces.

According to a particular implementation of the invention, the yeasts added to the permeate during step (b) are of the species Saccharomyces cerevisiae.

### Optional Step (c)

According to a particular implementation of the method according to the invention, this comprises a step of diafiltration of the retentate with the metabolised permeate, in order to obtain:
a “diafiltered retentate” having a value ABV(R diafiltered) less than ABV(R), and
a “diafiltered metabolised permeate” having an ABV value greater than ABV(P metabolised), said diafiltered metabolised permeate then being able to be subjected again to the method of step (b), in particular in order to reduce its ABV value.

This diafiltration step of the retentate can reduce ABV(R) of the retentate.

This diafiltration step is carried out with a metabolised permeate having an ABV value less than that of the retentate to be diafiltered.

Preferably, at the end of this diafiltration step, ABV(R diafiltered) of the retentate will have a value of approximately 4 vol. %, preferably less than or equal to 4%, or even less than or equal to 3 vol. %, and this in order to obtain, after step (d) of combination with the metabolised permeate, a dealcoholised wine with ABV less than or equal to 0.5 vol. % while conserving the initial proportions of retentate/permeate.

This optional step is put in place, in particular, in the case where the method is implemented with the aim of obtaining a totally dealcoholised wine having a value ABV(2) less than 0.5 vol. %.

Diafiltration is a dilution process which involves the separation of certain components of a liquid containing soluble and filterable molecules, based on sorting the molecules according to their size and their concentration using more or less nanometric permeable filters.

Diafiltration is in fact a “washing” operation in which a “diafiltration agent” is added, continuously or non-continuously, to a solution in order to selectively entrain certain components of the thus “washed” solution. It can be carried out in various ways:
continuous diafiltration, at constant volume: a diafiltration agent (here, the metabolised permeate) is continuously added at the same flow rate as the flow of permeate from step (a). The ethanol is gradually removed from the retentate as the metabolised permeate is added.
sequential diafiltration: the operation is performed in batch mode, by a dilution followed by a concentration. The metabolised permeate is added sequentially to the retentate before re-concentrating this mixture.

When this technique is carried out sequentially, two new fractions are obtained and, in particular, a retentate for which the ABV value has been lowered. This diafiltration step is implemented as many times as necessary with regard to the desired lowering of the ABV value.

Advantageously, this diafiltration step is carried out at least twice, preferably at least three times in a row, in order to lower the ABV of the retentate.

Advantageously, this diafiltration is carried out with the same membrane or a membrane of the same type as that used for the membrane separation of step (a), in other words a membrane having a rejection rate for salts greater than 0.9.

Advantageously, this diafiltration step is carried out without any addition of exogenous liquid, in other words without input, using the, optionally filtered, metabolised permeate as diafiltration agent; thus all the elements used in the method come from the initial wine. The use of an endogenous diafiltration agent, because obtained uniquely from the initial wine, is a particularly characterising and advantageous feature of the invention.

The term “diafiltration rate” designates the number of sequential or continuous dilutions of the retentate by diafiltration.

### Metabolised Permeate as Obtained and the Use Thereof

The present invention also relates to a method for obtaining a metabolised permeate, comprising the following steps:
a) separating a wine into two fractions using a membrane separation method:
   one fraction concentrated by a factor k referred to as “retentate”, the volume of this fraction being equal to 1/k V1, this fraction having a value ABV(R);
   one fraction referred to as “permeate” mainly comprising water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the fraction thus obtained being referred to as “metabolised permeate” and having a value ABV(P metabolised) less than ABV(P).

The present invention also relates to a metabolised permeate that can be obtained by implementing the method described above.

According to one implementation, this metabolised permeate is obtained in step (b) of the method described in the present application, and has a value ABV(P metabolised) less than ABV (P), preferably less than 1 vol. %, or less than 0.8 vol. %, or even less than 0.5 vol. %, and more preferably equal to 0 vol. %.

According to another implementation, the metabolised permeate is obtained from a mixture of metabolised permeates obtained during the repeated implementation of steps a and b of the method of the invention.

Advantageously, this metabolised permeate has an ABV(P metabolised) with a value less than 5 vol. %, less than 4%, less than 3%, less than 2% or less than 1 vol. %, less than 0.5 vol. %, and more preferably equal to 0 vol. %.

The present invention also relates to the use of this metabolised permeate as a dilution agent of the permeate during step (a′) or as diafiltration agent of the retentate during optional step (c).

In the context of this use, the metabolised permeate will have an ABV value less than that of the retentate to be diluted or to be diafiltered.

Advantageously, the metabolised permeate will be filtered before any subsequent use.

This, optionally filtered, metabolised permeate, can be used in the implementation of another step of the method of the invention: during step (d), for the preparation of a volume V2 of dealcoholised wine, by combining with a volume of retentate, as indicated in detail below.

### Application of the Method According to the Invention for the Partial or Total Dealcoholisation of a Wine

The method according to the invention can be applied in order to obtain different final products:
a) to obtain a partially dealcoholised wine; or
b) to obtain a totally dealcoholised wine.

Hence, according to a first aspect, the invention relates to a method for partial dealcoholisation of a volume V1 of wine.

This method for partial dealcoholisation comprises the implementation of the following steps:
a) separating the volume V1 of a wine into two fractions using a membrane separation method:
   one fraction concentrated by a factor k referred to as “retentate”, the volume of this fraction being equal to 1/k V1, this fraction having a value ABV(R);
   one fraction referred to as “permeate” mainly comprising water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the fraction thus obtained being referred to as “metabolised permeate” and having a value ABV(P metabolised) less than ABV(P); and
d) combining a volume of retentate and a volume of metabolised permeate, in order to obtain a volume V2 of dealcoholised wine, having a value ABV(2) less than ABV(1).

The partially dealcoholised wine thus obtained will have an ABV value less than that of the starting wine.

According to a second aspect, the invention relates to a method for total dealcoholisation of a volume V1 of wine.

This method for total (or complete) dealcoholisation of a volume V1 of wine comprises the implementation of the following steps:
a) separating the volume V1 of a wine into two fractions using a membrane separation method:
   one fraction concentrated by a factor k referred to as “retentate”, the volume of this fraction being equal to 1/k V1, this fraction having a value ABV(R);
   one fraction referred to as “permeate” mainly comprising water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the fraction thus obtained being referred to as “metabolised permeate” and having a value ABV(P metabolised) less than ABV(P);
c) diafiltrating the retentate with the metabolised permeate having an ABV of value equal to 0 vol. %, in order to obtain:
   a “diafiltered retentate” having a value ABV (R diafiltered) less than ABV(R), and
   a “diafiltered metabolised permeate” having an ABV value greater than ABV(P metabolised), said diafiltered metabolised permeate then being subjected again to step (b) until obtaining an ABV value less than or equal to 0.5 vol. %, preferably equal to 0 vol. %;
d) combining a volume of diafiltered retentate, and a volume of metabolised permeate having an ABV value less than or equal to 0.5 vol. %, preferably equal to 0 vol. %, in order to obtain a volume V2 of dealcoholised wine having a value ABV(2) less than or equal to 0.5 vol. %.

In this implementation, the method comprises 4 steps, a, b, c, and d, carried out successively.

In this implementation and contrary to the method for partial dealcoholisation, the diafiltered metabolised permeate is subjected again to step (b) as often as necessary in order to reduce its ABV until it has an ABV(P metabolised) with a value less than or equal to 0.5%, preferably equal to 0 vol. %.

The totally dealcoholised wine thus obtained will have an ABV value less than 0.5 vol. %.

### Step (d) of Combining Two Fractions

The last step of the method comprises combining a volume of retentate or diafiltered retentate and a volume of metabolised permeate, in order to obtain a volume V2 of dealcoholised wine, having a value ABV(2) less than ABV(1).

The term “combining” is synonymous with reuniting, mixing or even regrouping, and designates the fact that the two fractions previously separated in step (a) are totally or partially reunited, in order to compose a certain volume of dealcoholised wine.

According to one implementation of the method, the metabolised permeate is filtered beforehand, in order to remove any undesirable residue in the dealcoholised wine of volume V2. Such an implementation is well known to a person skilled in the art.

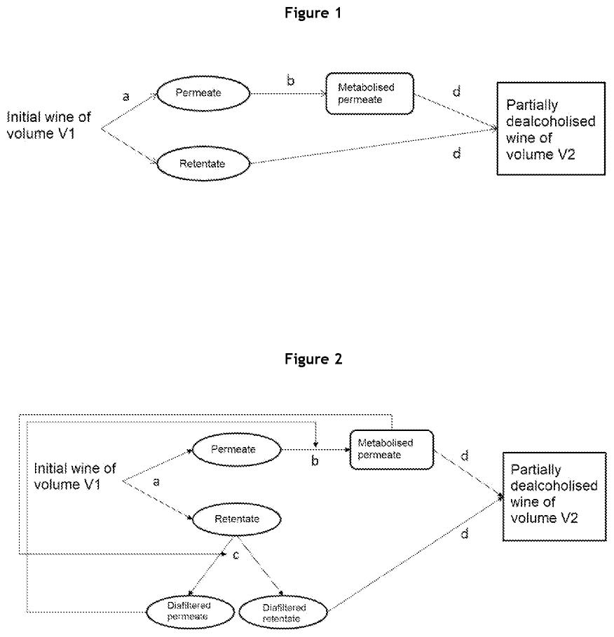

A complete method for partial dealcoholisation is illustrated in FIG. 1: in this example, the partially dealcoholised wine of volume V2, consists of the metabolised permeate and the retentate obtained during steps a and b.

A complete method for total dealcoholisation is illustrated in FIG. 2: in this example, the completely dealcoholised wine of volume V2, consists of metabolised permeate and diafiltered retentate obtained by implementation of steps a, b and c.

According to a preferred implementation, the combination of the two fractions composing the volume V2 of dealcoholised wine is carried out according to the following proportions:
the volume of the metabolised permeate, or of filtered metabolised permeate, is equal to (k−1)/k V2; and
the volume of the retentate, or of diafiltered retentate, is equal to 1/k V2, this makes it possible to conserve the initial separation proportions of the two fractions.

The combination of the two fractions composing the volume V2 of dealcoholised wine can be carried out according to all the respective proportions of retentate and metabolised permeate which are considered advantageous by a person skilled in the art.

However, this combination is preferably carried out respecting the respective proportions of retentate and permeate obtained during step (a) of the method, the function of the applied concentration factor k.

More specifically, as a person skilled in the art will easily understand, the method according to the invention is inevitably accompanied by a slight loss of volume of the initial wine, this being due to the successive transfer of liquids.

Since the ethanol present in the permeate is metabolised into water and CO₂ during step (b), according to the following chemical equation:

CH₃—CH₂—OH+3O₂->2CO₂+3H₂O,

the volume loss linked to the removal of ethanol is limited because the volume of ethanol is partially replaced by the volume of water.

According to a particular implementation, the method according to the invention does not include an addition of exogenous water or of another liquid in order to compensate this loss of volume.

In any case, in order to conserve as well as possible the gustatory qualities of the dealcoholised wine relative to the gustatory qualities of the initial wine, it is recommended to try to preserve the typicality of the initial wine and in particular the initial proportions of the compounds of interest, and in particular the flavour compounds, which have been concentrated by a factor of k in the retentate.

Hence, in the case where k=8, ⅞ of metabolised permeate (coming from one or more cycles) will be blended with ⅛ of retentate (coming from one or more cycles) in order to obtain a partially or totally dealcoholised wine, as a function of the ABV of the metabolised permeate and the retentate used for the combination.

The dealcoholised wine thus obtained has an ABV(2) of value less than the ABV of the initial wine, designated ABV(1).

In the case of a method for total dealcoholisation, during step (d), a diafiltered retentate having a value ABV(R diafiltered) less than or equal to 4 vol. %, is preferably combined with a metabolised permeate having a value ABV(P metabolised) equal to 0 vol. % This makes it possible to respect, in the dealcoholised wine, the respective proportions of the two fractions initially obtained following the membrane separation step.

### Various Operating Modes of the Method of the Invention

The method of the invention can be, in particular, carried out in “batch” mode or in “fed-batch” mode.

When the method is carried out in “batch” mode or in “fed-batch” mode, step (d) of combining the fractions consists in combining:
the retentate obtained in step (a) which has been conserved, optionally diafiltered, and
the metabolised permeate obtained during step (b), optionally filtered.

According to an implementation of the invention, the combining of the two fractions constituting the dealcoholised wine is performed by reuniting the metabolised permeate obtained during one or more successive cycles, or during the course of a previously implemented method, and/or the retentate (optionally diafiltered) obtained during one or more successive cycles.

According to a particular implementation, all the metabolised permeates coming from all the preceding cycles are mixed and therefore can no longer be distinguished as a function of the cycle in which they were obtained; in this case, the expression “metabolised permeate” designates a permeate fraction having been subjected to ethanol metabolisation step (b), without distinguishing the cycle in which it was obtained.

According to a particular implementation, all the retentates coming from all the preceding cycles are mixed and can no longer be distinguished as a function of the cycle in which they were obtained; in this case, the term “retentate” designates a retentate fraction having been obtained in membrane separation step (a), optionally diafiltered in step (c), without distinguishing the cycle in which it was obtained.

### Specific Implementations of the Method and Additional Steps of the Method

Within the meaning of the invention, it is intended that the method comprises essential steps (a), (b) and (d), but can comprise other optional steps, which can optimise or improve the claimed method, such as previously described steps (a′) and (c).

According to an implementation, the method comprises steps a, b and d of the method.

According to another implementation, the method consists in steps a, b and d of the method.

According to another implementation, the method comprises steps a, b, c and d of the method.

According to another implementation, the method consists in steps a, b, c and d of the method.

According to another implementation, the method comprises steps a, a′, b, c and d of the method.

According to another implementation, the method consists in steps a, a′, b, c and d of the method.

Furthermore, it will be advantageous to add to the method additional steps enabling each fraction obtained during the method to be used, thus reducing the inherent waste from the implementation of said method.

According to an implementation of the method, the wine subject to the method of the invention is a white wine, a rose wine or a red wine.

According to an implementation of the method, the wine subjected to the method of the invention contains less than 10 g/L of residual sugars.

According to an implementation of the method according to the invention, the wine subjected to the method of the invention is a white wine, a rose wine, a red wine, and/or a still wine or a sparkling wine, optionally degassed beforehand. It can, in particular, involve a base wine, in other words a wine intended for the production of a sparkling wine but before the carbonation step.

When the wine subjected to the method according to the invention is a sparkling wine, it can be advantageous to degas this wine beforehand. According to this implementation of the method according to the invention, it is possible after combination step (d), to introduce CO₂ into the dealcoholised wine obtained, having volume V2.

According to another implementation of the method, it will be possible, after the combination step, to filter the volume V2 of dealcoholised wine obtained, for example over carbon, in order to remove any potential undesirable compounds.

All these additional steps are well known to a person skilled in the art and do not need to be explained in more detail.

### Final Blending of the Dealcoholised Wine—the Case of a Sparkling Wine, in Particular a Champagne

According to a particular implementation, the method is carried out without the addition of a dealcoholisation input, in particular without the addition of exogenous water, and hence the dealcoholised wine, after combining the two fractions, only consists of elements coming from the initial wine.

This is particularly advantageous from a regulatory point of view, for wines for which the properties are defined by an Appellation d'Origine Contrôlée (AOC), properties which must be strictly respected.

The large majority of Champagne wines comes from a blend of different vintages, of three main Champagne grape varieties (Chardonnay, Pinot noir and Pinot meunier), from previous harvests, incorporated in varying percentages.

Whatever its specificity, a blend almost always calls on the three previously mentioned parameters: terroirs, grape varieties and years.

The blending is carried out by each winemaker in order to obtain a balance, a particular harmony between the various properties sought, an individual style.

Champagne wines are also characterised by a fermentation in the bottle which enables the “prise de mousse” in other words the carbonation of the wine by in situ production of CO2 trapped in the bottle. It is also possible to carry out this carbonation of the wine in tanks with exogenous CO₂, as is the case for other sparkling wines which are not produced by the method referred to as “Champagne method”, characterised in particular by this secondary fermentation in the bottle.

The dealcoholisation method according to the present invention can be carried out on a Champagne wine, after its blending, tirage (bottling of the case wine), prise de mousse and degasification; or can be implemented on a still wine, before or after blending, said still wine being intended for obtaining a Champagne wine.

The invention concerns, in particular, a method for dealcoholisation of a still wine obtained by degassing of a Champagne wine ready for consumption.

The method according to the invention can also be implemented on a still wine intended to be used in a blend in order to obtain a Champagne wine or any other type of sparkling wine.

Thus, the present invention relates to a method for dealcoholisation of a volume V1 of a still wine as described above, having a percentage of alcohol by volume (ABV) with value ABV(1), comprising the implementation of the following steps:
a) separating the volume V1 of a wine into two fractions using a membrane separation method:
   one fraction concentrated by a factor k referred to as “retentate”, the volume of this fraction being equal to 1/k V1, this fraction having a value ABV(R);
   one fraction referred to as “permeate” mainly comprising water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the fraction thus obtained being referred to as “metabolised permeate” and having a value ABV(P metabolised) less than ABV(P);
c) optionally, diafiltrating the retentate with the metabolised permeate, in order to obtain:
   a “diafiltered retentate” having a value ABV (R diafiltered) less than ABV(R), and
   a “diafiltered metabolised permeate” having an ABV value greater than ABV(P metabolised), said diafiltered metabolised permeate then being optionally subjected again to step (b);
d) combining a volume of retentate or diafiltered retentate and a volume of metabolised permeate, in order to obtain a volume V2 of dealcoholised wine, having a value ABV(2) less than ABV(1).

All the other particular implementations presented in the present application are applicable to this method for dealcoholisation of still wine, coming from a Champagne or intended to be blended in order to obtain a Champagne wine.

In particular, said dealcoholisation can be partial or complete.

After dealcoholisation, the dealcoholised still wine obtained can be subjected to any necessary step to arrive at a dealcoholised sparkling wine: blending, carbonation, bottling, etc.

### EXAMPLES

### Example 1. Physical Separation by Reverse Osmosis of a Dry White Wine into Two Fractions, Permeate 1 and Retentate 1 (Step a)

The equipment for reverse osmosis substantially consists of a high-pressure pump that can deliver up to 60 bars, and a 2·5-inch diameter reverse osmosis membrane (Reference: Alfa Laval RO98pHt). 26 m² of membrane were installed.

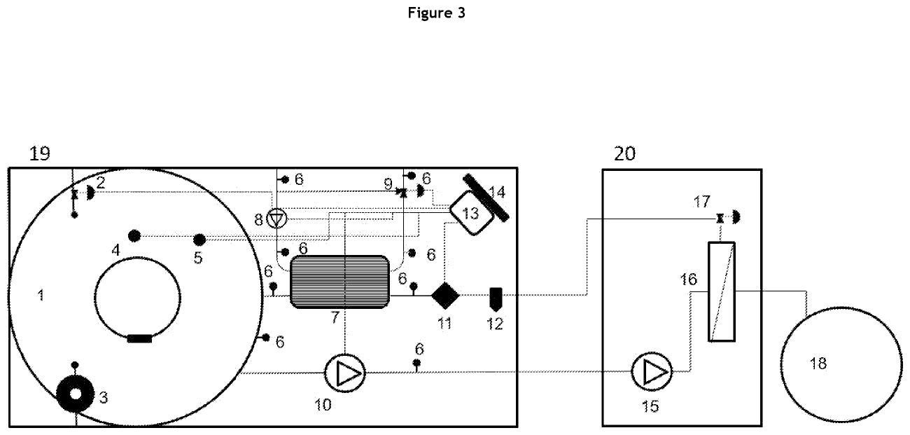

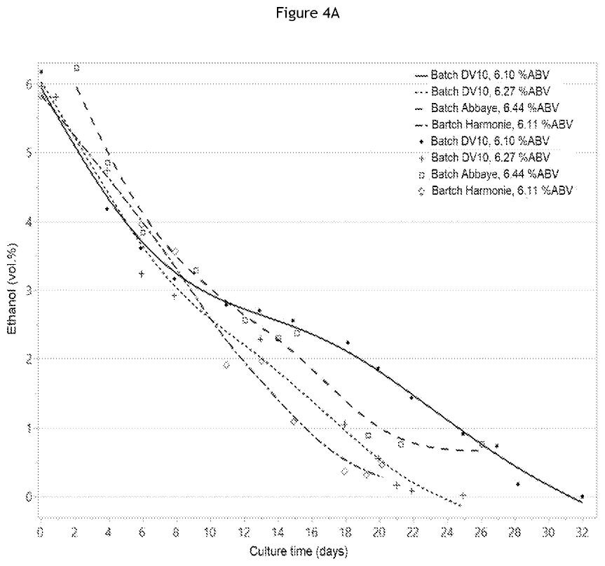

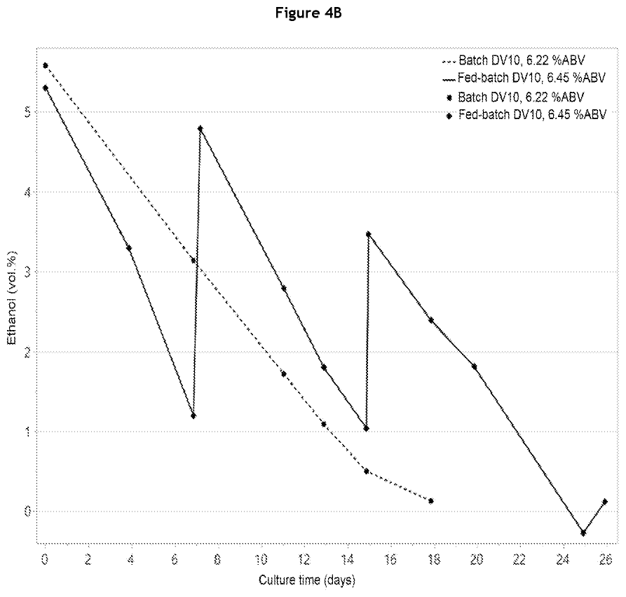

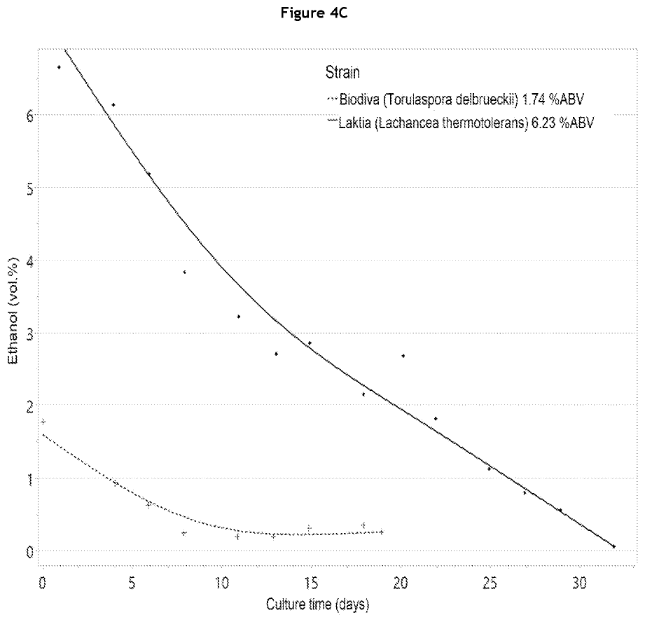

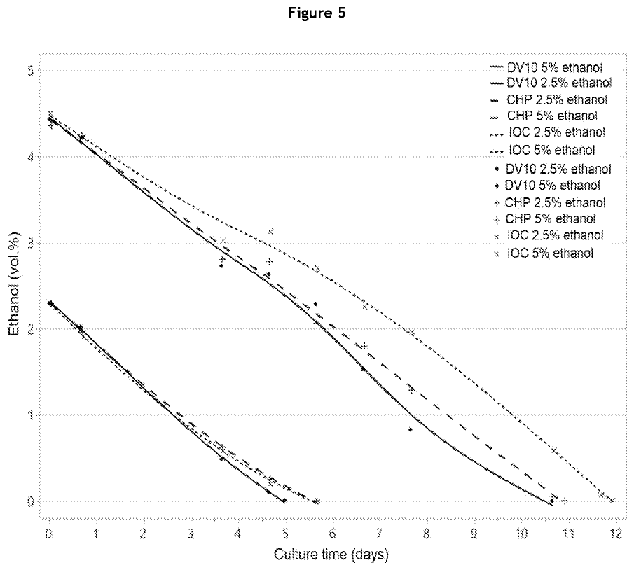

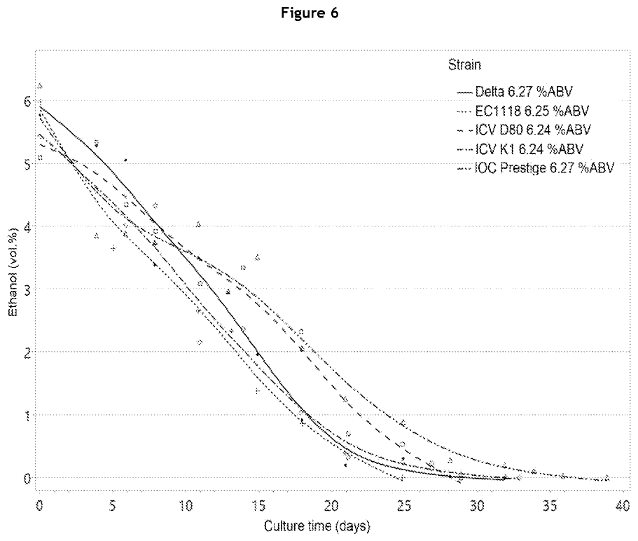

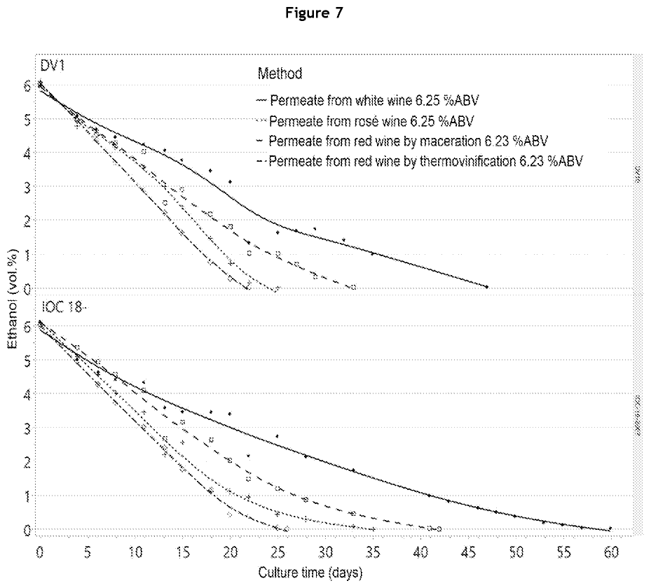

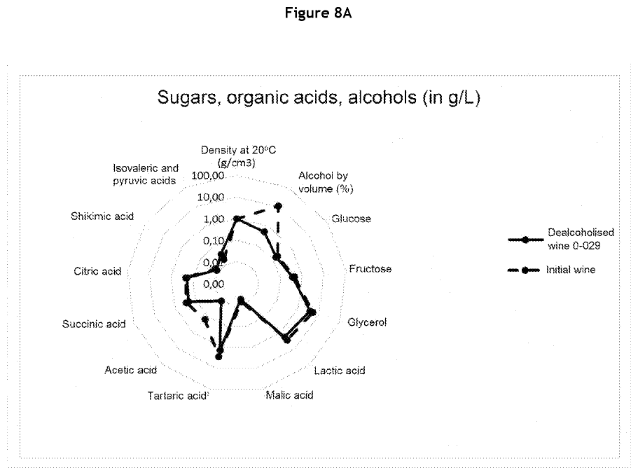

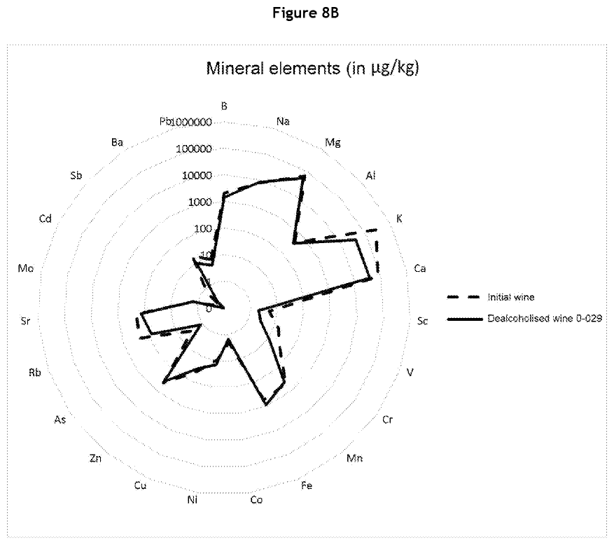

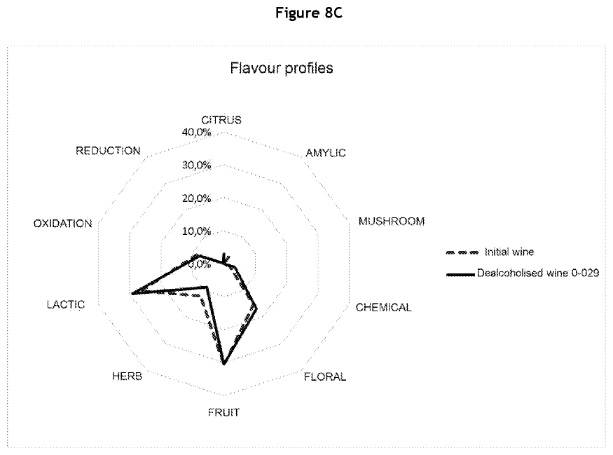

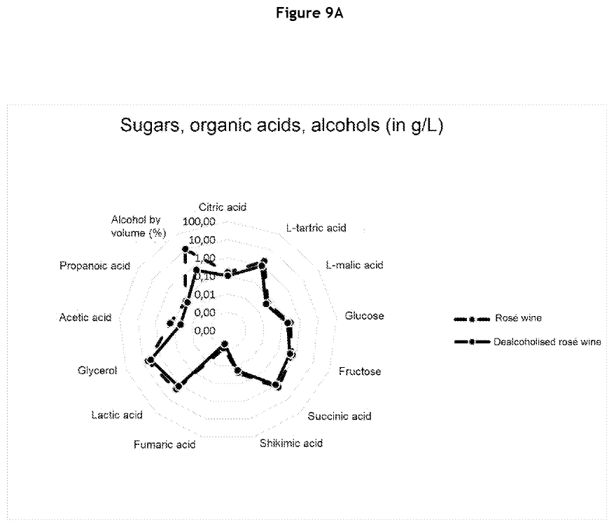

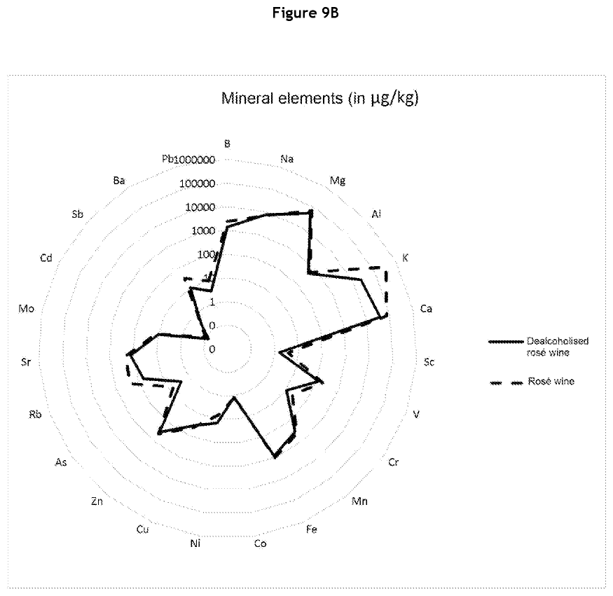

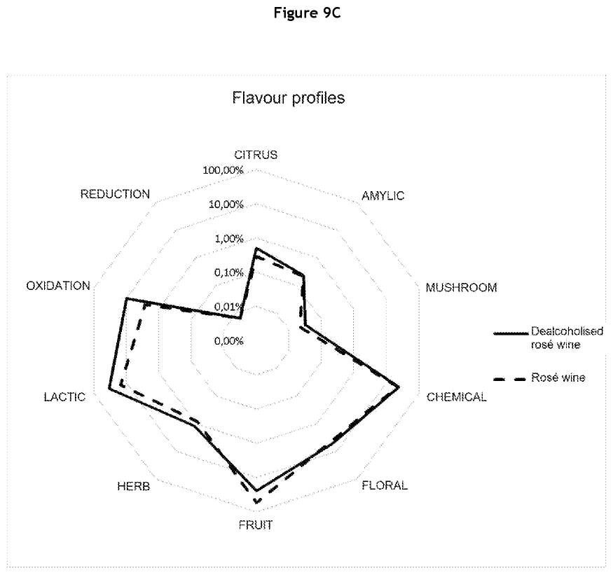

An equipment diagram is shown in FIG. 3.

The wine used is a dry white wine, having less than 10 g/L residual sugars, having an ABV value equal to 11.5 vol. %.

500 litres of wine are introduced into the feed tank (1), that has been inerted beforehand. The tank is then hermetically closed, a tank head containing less than 2% of O₂is maintained by successive additions of nitrogen via the regulator (3).

The feed device is then hydraulically connected to the reverse osmosis device (RO, central rectangle), and the wine is pumped to the RO equipment by means of the centrifugal pump (10) of the feed device. Then, the positive displacement pump (15) of the RO device is switched on in order to make the wine circulate in the vicinity of the membrane (16), the portion of wine leaving the RO device returning to the feed tank via the strainer (12), the mass flow meter (11) and the plate exchanger (7). The strainer (12) can retain the scale crystals appearing due to the concentration. The mass flow meter (11) can read the flow rate and also the density, thus monitoring the concentration throughout the process. The exchanger (7) can dissipate the energy contributed by the positive displacement pump (15) and thus regulate the temperature at approximately 15° C. for the retentate loop. The pressure is obtained by gradually closing the pressure valve (17), typically until obtaining a pressure of approximately 50 bars at the inlet of the membrane.

In this example, the separation is performed at a pressure of approximately 50 bars, continuously maintained on the retentate side. The operation is continued until attaining a VCF (volume concentration factor) of k=8.

The flow rate (L/h/m2) applied to the membrane gradually reduces the flow of the permeate. The quantity of ethanol by mass passing into the permeate is measured instantaneously over time, using a density meter. The ethanol/permeate titre (vol. %) is calculated from the mass percentage of ethanol, taking into account the density of ethanol (789 g/L) in other words by dividing the mass percentage of ethanol by 0.789.

Table 2 below presents the measurements obtained during a test with an ALFA LAVAL RO98pHt membrane used in a reverse osmosis method applied to a dry white wine.

TABLE 2

| | | Ethanol/ | Ethanol/ | | |
|---|---|---|---|---|---|
| Time | Permeate | permeate | permeate | VCF | Flow rate |
| (min) | (kg) | titre (% m/m) | titre (% vol.) | (k) | (L/h/m²) |
| 0 | | | | | |
| 10 | 17 | 3.8 | 4.8 | 1.03 | 7.7 |
| 60 | 124 | 4.8 | 6.1 | 1.32 | 5.2 |
| 120 | 223 | 6.1 | 7.7 | 1.77 | 3.4 |
| 180 | 296 | 7.6 | 9.6 | 2.36 | 2.3 |
| 240 | 348 | 9.3 | 11.8 | 3.09 | 1.4 |
| 300 | 387 | 10.7 | 13.6 | 4.04 | 1.4 |
| 360 | 416 | 12.1 | 15.3 | 5.23 | 0.9 |
| 400 | 431 | 13 | 16.5 | 6.18 | 0.9 |
| 410 | 434 | 13.2 | 16.7 | 6.41 | 0.7 |
| 420 | 439 | 12.8 | 16.2 | 6.83 | 1.1 |
| 430 | 443 | 13.1 | 16.6 | 7.22 | 0.9 |

Hence 60 litres (L) of retentate and 440 litres (L) of permeate are obtained.

The ABV of the permeate is measured instantaneously during its flow, and therefore does not reflect the final ABV of the final homogenised permeate, which is 10 vol. %. It is observed, however, that over time, the ABV of the permeate which flows increases.

The experiment has also been carried out on sweet white wine, with lower flow rate: the results obtained are presented in example 13.

### Example 2. Method According to the Invention with k=2 for Obtaining a Dry White Wine with Low Alcohol Content (Partial Dealcoholisation)

A dry white wine having an ABV of 11.6 vol. % is treated according to the method of the invention.

The first step (a) of physical separation is carried out using a membrane, by reverse osmosis, under a pressure of 50 bars, as described for example 1.

The concentration factor of the retentate is equal to 2, which enables the following distribution to be obtained:

TABLE 3

| Product or | | | | | | |
|---|---|---|---|---|---|---|
| fraction | Wine | | Permeate | | Retentate | |
| Volume | 2/2 | | 1/2 | | 1/2 | |
| Observed ABV of | 11.6 | vol. % | 7.73 | vol. % | 15.46 | vol. % |
| each fraction | | | | | | |
| Concentration of | 91.5 | g/L | 61.0 | g/L | 122.0 | g/L |
| ethanol in each | | | | | | |
| fraction (g/L) | | | | | | |

Step (b) is then carried out in such a way as to obtain a permeate having an ABV value equal to 0 vol. %.

No diafiltration of the retentate is carried out.

During combination step (d), all of the metabolised permeate and all of the retentate are blended, according to the following proportions:
½ volume of permeate at 0 vol. %, and
½ volume of retentate at 15.46 vol. %

Thus, a volume V2 is obtained of dealcoholised wine having an ABV(2) equal to 7.73%, i.e. a value equal to ⅔ of the initial ABV(1).

### Example 3. Culture Medium for Yeasts Used During Step (b)

Several types of culture media can be used in order to pre-culture yeasts during steps (b1) and (b2) of the method.

The medium for which the composition is presented in Table 4 below is considered to be the optimum culture medium for carrying out the method according to the invention. The pH of this medium is 3.2. This medium was prepared from a synthetic must medium.

TABLE 4

| Compounds | Quantity | Units |
|---|---|---|
| Sucrose | 80 | g/kg |
| Magnesium sulfate | 0.25 | g/kg |
| Potassium sulfate | 0.5 | g/kg |
| Calcium chloride | 0.155 | g/kg |
| Tartaric acid | 5 | g/kg |
| Malic acid | 5 | g/kg |
| DAP (NH4)2HPO4 | 1.749 | g/kg |
| Zinc sulfate heptahydrate | 4 | mg/kg |
| Biotin | 3 | μg/kg |
| Calcium pantothenate | 1500 | μg/kg |
| Inositol (myo-inositol) | 50000 | μg/kg |
| Thiamine hydrochloride | 318 | μg/kg |
| Qsf 1 kg | Water | |

### Example 4. Yeast Preculture and Culture Steps

Step (b) takes place in three sub-phases, referred to as b1, b2 and b3.

The first two phases enable the yeast to be “conditioned” for phase b3, referred to as the metabolisation or transformation step of the ethanol of the permeate. The yeasts thus acquire good viability, a biomass and accumulate the nutrients necessary (for example ions, nitrogen, vitamins, unsaturated lipids) for the ethanol metabolisation phase, which may be long.

A typical example of culture during the various phases is given below:
1. Phase b1: in an Erlenmeyer flask, with a cotton wool plug, from LSA (Levures Sèches Actives), at 28° C., under stirring at 150 rpm for 27 hours; the plug is permeable and therefore the culture is carried out under “light” aerobic conditions.
2. Phase b2: in a fermenter, at 23° C., while stirring at 150 rpm, for 41.5 hours, with aeration according to the following conditions: O₂ 0.004 volume/volume/min (vvm) and N₂ 0.008 vvm.
3. Phase b3: in a fermenter, at 25° C., while stirring 150 rpm, with aeration according to the following conditions: O₂ 0.0024 vvm and N₂ 0.0048 vvm.

### Example 5. Microbiological Step (b) Carried Out on a Permeate

The examples presented below have been carried out on the permeate from white wine.

It involves a permeate with approximately 10 vol. % alcohol, from a separation reverse osmosis of a white wine, then diluted to a starting ABV of approximately 6 vol. %, by the addition of spring water (brand: Cristaline).

The yeasts were cultivated beforehand under the conditions described for steps (b1) and (b2) before their addition to the permeate, at a concentration of at least 2·10⁸ yeasts per millilitre of permeate.

The tested yeasts are briefly described below:
The strain “LalBrew® Abbaye” is a Belgian brewer's yeast with high fermentation, from the species Saccharomyces cerevisiae. It is distributed by Lallemand.
The strain “Vitilevure® DV10” distributed by Danstar is a yeast of the species Saccharomyces cerevisiae, used in vinification and for producing effervescent wines (for “prise de mousse”).
The strain IOC Harmonie® is a yeast of the species Saccharomyces cerevisiae, having a high resistance to ethanol, used in vinification. It was selected by the University of California, Davis, and is known by the reference 522 Davis. It is distributed by the IOC under the commercial name Harmonie.

Table 5 below presents various metabolisation tests of the ethanol present in the permeate.

Two conditions were tested: in “batch” mode and in “Fed-batch” mode.

The conditions of the “Batch” mode are as follows: start in a fermenter in at full working volume, on permeate diluted with Cristaline water, in order to obtain an ABV value of approximately 6 vol. %.

The conditions of the “Fed-batch” mode are as follows: start in a fermenter with minimum volume (40% of the final volume of the fermenter) on permeate diluted with Cristaline water in order to obtain an ABV value of approximately 6 vol. % The “Fed-Batch” additions are made with the same permeate without dilution. Hence, under Fed-Batch conditions, the volume of diluent is reduced. During the ethanol metabolisation process, when the ABV value is at approximately 0.5 vol. %, the permeate is added in order to increase the ABV value to 4.6 vol. %, and then continues until the maximum volume of the fermenter is obtained.

TABLE 5

| | | | | ABV | ABV | Total |
|---|---|---|---|---|---|---|
| | Volume | Yeast strain | | start | end | duration |
| Test | (L) | tested | Type | (vol. %) | (vol. %) | (d) |
| 98 | 1.2 | Lallbrew Abbaye | Batch | 6.29 | 0.16 | 28 |
| 99 | 1.2 | Danstar DV10 | Batch | 6.22 | 0.13 | 21 |
| 99 | 1.2 | Danstar DV10 | Fed- | 6.57 | 0.12 | 29 |
| | | | Batch | | | |
| 101 | 1.2 | Danstar DV10 | Batch | 6.19 | 0.11 | 35 |
| 106 | 1.2 | IOC Harmonie | Batch | 6.23 | 0.56 | 23 |

FIG. 4a illustrates the kinetics of metabolisation of ethanol by Saccharomyces cerevisiae yeast strains, using the data presented in Table 5 above, in batch mode.

FIG. 4b illustrates the kinetics of metabolisation of ethanol by the strain DV10, in batch and fed-batch modes.

Another test of metabolisation of ethanol of a permeate from dry white wine was carried out.

The two strains used are non-Saccharomyces species:
Levure Laktia™ (Lachancea thermotolerans) selected and marketed by Lallemand CEnologie for increasing lactic acid in vinifications, especially in hot regions;
Biodiva™ (Torulaspora delbrueckii) selected and marketed by Lallemand CEnologie to improve the flavour and gustatory complexity and the production of syrupy wines, natural sweet wines, late harvests, and ice wines.

The examples presented in FIG. 4c have been carried out on the permeate from white wine. It involves a permeate with approximately 10 vol. % alcohol, from a separation reverse osmosis of a white wine, then diluted to a starting ABV as noted below with the addition of spring water (brand: Cristaline).

The yeasts were cultivated beforehand under the conditions described for steps (b1) and (b2) before their addition to the permeate, at a concentration of at least 2·10⁸ yeasts per millilitre of permeate.

In order to start step b3, the yeasts were added to permeates for which the ABV was equal to:
6.23 vol. % ethanol for the strain Laktia™, and
1.74 vol. % ethanol for the strain Biodiva™
   in a volume of 1.2 litre (1.2 L) of permeate.

The culture conditions are identical to those of example 4 with several variations, in particular:
phase b2 was conducted at 25′C, with an oxygen flow rate of 0.008 vvm and a nitrogen flow rate of 0.016 vvm;
during phase b3, the oxygen flow rate is 0.004 vvm and the nitrogen flow rate is 0.008 vvm for the strain Biodiva™, and the oxygen flow rate is 0.008 vvm and nitrogen flow rate is 0.016 vvm for the strain Laktia™

At the end of the culture, the yeasts are removed by centrifugation and filtration at 0.2 μm, then the metabolised permeate is stored in sterile bottles.

The results are presented in FIG. 4c: for a starting ABV value equal to 6.23 vol. % the duration of the ethanol metabolisation step was 32 days for the strain Laktia™; for a starting ABV of value equal to 1.74 vol. % the duration of the ethanol metabolisation step was 8 to 11 days for the strain Biodiva™ but with a small remainder of ethanol at 0.2 vol. %.

FIG. 4c illustrates the kinetics for metabolisation of ethanol by the non-Saccharomyces strains Lachancea thermotolerans and Torulaspora delbrueckii.

### Example 6. Microbiological Step (b3) Carried Out on a Permeate

Another test of metabolisation of ethanol of the permeate was carried out under the conditions specified below. The results are presented in FIG. 5.

The tested strains are all from the Saccharomyces cerevisiae species, all indigenous to champagne viticulture and all known to be used for the vinification of a champagne or, more generally, sparkling wines vinified according to the Champagne method:
Vitilevure DV10® and Levuline CHP®, selected by the CIVC (Comité Interprofessionnel du vin de Champagne) and marketed by Danstar; and
IOC18-2007, selected and marketed by the IOC (Institut CEnologique de Champagne).

The yeasts are added to the permeate for which the ABV is equal to 2.5 vol. % or 5 vol. % of ethanol; in a volume of 1.2 litre (1.2 L) of permeate; while stirring at 150 rpm; at 25° C.

The culture conditions are identical to those of Example 4 with several variations, in particular: the yeast inoculation rate is 3 to 4·10⁸ yeasts per millilitre, with an oxygen flow rate of 0.007 vvm and a nitrogen flow rate of 0.016 vvm.

At the end of the culture, the yeasts are removed by centrifugation and filtration at 0.2 μm, then the metabolised permeate is stored in sterile bottles.

The results are presented in FIG. 5: for the permeate having a starting ABV of value 2·5 vol. %, 5 to 6 days are sufficient to obtain an ABV value equal to 0 vol. %; for a starting ABV of value equal to 5 vol. %, the duration of the ethanol metabolisation step is between 10 and 12 days, depending on the strain of yeast used.

### Example 7. Diafiltration of the Retentate with the Metabolised Permeate as Diafiltering Agent

This example illustrates optional step (c) of the method according to the invention, which is implemented according to a particularly preferred embodiment of the invention.

Here, the diafiltration of the retentate is carried out with the preferred diafiltering agent according to the invention, a metabolised permeate with an ABV value of 0 vol. %, at a pressure of approximately 50 bars, until attaining a diafiltration rate of 1. This involves an instantaneous measurement, the values presented below thus not representing the final result.

TABLE 6

| | At the inlet: | At the outlet: | Diafiltered | | |
|---|---|---|---|---|---|
| | Mass of | Mass of | metabolised | | |
| | metabolised | diafiltered | permeate/ | | |
| | permeate | metabolised | ethanol | Flow | Diafil- |
| Time | (diafiltering | permeate | titre | rate | tration |
| (min) | agent) (kg) | (kg) | (% m/m) | (L/h/m²) | rate |
| 0 | | | | | |
| 10 | 5.65 | 4 | 12.4 | 0.9 | 0.06 |
| 20 | 11.2 | 8 | 11.8 | 0.9 | 0.13 |
| 30 | 16.65 | 12 | 10.8 | 0.9 | 0.19 |
| 40 | 22.15 | 17 | 9.9 | 1.1 | 0.27 |
| 50 | 27.65 | 22 | 9 | 1.1 | 0.34 |
| 60 | 33.15 | 27 | 8.2 | 1.1 | 0.42 |
| 70 | 38.65 | 32 | 7.6 | 1.1 | 0.50 |
| 80 | 44.1 | 38 | 7 | 1.4 | 0.59 |
| 90 | 49.6 | 44 | 6.4 | 1.4 | 0.69 |
| 100 | 55.1 | 50 | 6 | 1.4 | 0.78 |
| 110 | 60.5 | 56 | 5.7 | 1.4 | 0.88 |
| 120 | 64 | 64 | 5.3 | 1.4 | 1.00 |

This diafiltration step can be carried out as many times as necessary, so as to obtain a retentate having the desired ABV.

### Example 8. Metabolisation of Ethanol by Yeasts after Dilution of the Permeate with the Metabolised Permeate, Used as Dilution Agent

Another test of metabolisation of ethanol of the permeate from dry white wine was carried out under the conditions specified below. The results are presented in FIG. 6.

The examples presented below have been carried out on the permeate from white wine. It involves a permeate with approximately 10 vol. % alcohol, from a separative reverse osmosis of a white wine, then diluted by the addition of permeate 0 vol. % from a prior dealcoholisation cycle, so as to adjust the degree of alcohol of the mixture to 6.25 vol. %.

The tested strains are all from the Saccharomyces cerevisiae species:
The strain Vitilevure EC-1118® is a yeast of the Saccharomyces cerevisiae species, used for fermentation safety and prise de mousse and marketed by Danstar,
The strain Zyamaflore Delta® is a yeast of the species Saccharomyces cerevisiae, marketed by Laffort,
The strain Lalvin ICV D80 is a yeast of the species Saccharomyces cerevisiae, selected in Côte Rôtie in order to develop the concentrated and powerful flavour and gustatory characteristics of Mediterranean red wines,
The strain ICV K1 is a yeast of the species Saccharomyces cerevisiae selected in the Languedoc in order to improve the safety of alcoholic fermentation under difficult conditions, these last two strains being marketed by the ICV (Institut Coopératif du Vin),
The strain IOC Prestige is a yeast of the species Saccharomyces cerevisiae, selected for its fermentation of red wines which respect the terroir, and marketed by the IOC (Institut CEnologique de Champagne).

The yeasts were cultivated beforehand under the conditions described for steps (b1) and (b2) before their addition to the permeate, at a concentration of at least 2·10⁸ yeasts per millilitre of permeate. The culture conditions are identical to those of example 4 with several variations, in particular:
phase b2 was conducted at 25° C., with an oxygen flow rate of 0.008 vvm and a nitrogen flow rate of 0.016 vvm;
during phase b3, the oxygen flow rate is 0.004 vvm and the nitrogen flow rate 0.008 vvm.

In order to start step b3, the yeasts were added to a permeate for which the ABV is equal to 6.25 vol. % ethanol; in a volume of 1.2 litre (1.2 L) of permeate; while stirring at 150 rpm; at 25° C.

At the end of the culture, the yeasts are removed by centrifugation and filtration at 0.2 μm, then the metabolised permeate is stored in sterile bottles.

The results are presented in FIG. 6: for a starting ABV of value equal to 6.25 vol. %, the duration of the ethanol metabolisation step is between 25 and 39 days, depending on the strain of yeast used.

Another test of metabolisation of ethanol of the permeates from white wine, rose wine and red wine was carried out under the conditions specified below. The results are presented in FIG. 7.

This metabolisation was carried out on various permeates from white wine, rose wine, red wine by maceration, or red wine by thermovinification.

It involves, in each case, a permeate with approximately 10 vol. % alcohol, from a separation reverse osmosis, then diluted by the addition of permeate 0 vol. % from a prior dealcoholisation cycle, so as to adjust the degree of alcohol of the mixture to 6.25 vol. % The two strains tested are of the species Saccharomyces cerevisiae:
Vitilevure DV10® selected by the CIVC (Comité Interprofessionnel du vin de Champagne) and marketed by Danstar; and
IOC18-2007, selected and marketed by the IOC (Institut CEnologique de Champagne).

The yeasts were cultivated beforehand under the conditions described for steps (b1) and (b2) before their addition to the permeate, at a concentration of at least 2·10⁸ yeasts per millilitre of permeate. The culture conditions are identical to those of example 4 with several variations, in particular:
phase b2 was conducted at 25° C., with an oxygen flow rate of 0.008 vvm and a nitrogen flow rate of 0.016 vvm;
during phase b3, the oxygen flow rate is 0.004 vvm and the nitrogen flow rate 0.008 vvm.

In order to start step b3, the yeasts are added to a permeate for which the ABV is equal to 6.25 vol. % ethanol; in a volume of 1.2 litre (1.2 L) of permeate.

At the end of the culture, the yeasts are removed by centrifugation and filtration at 0.2 μm, then the metabolised permeate is stored in sterile bottles.

The results are presented in FIG. 7: for a starting ABV of value equal to 6.25 vol. %, the duration of the ethanol metabolisation step is between 22 and 58 days, depending on the strain of yeast used and the type of permeate.

### Example 9. Complete Method for Total Dealcoholisation of a Dry White Wine and Characterisation of the Organoleptic Properties of the Various Fractions (Retentate, Permeate, Metabolised Permeate) and of the Dealcoholised Wine Obtained, Using Physicochemical Parameters and Tasting Comments

All the fractions produced and used in this example (permeate, filtered permeate, retentate, diafiltered retentate, etc.) are from a single batch of wine but from several different cycles.

The values indicated in this example are approximations to one decimal place of the effectively measured values, except in the tables.

### Step (a):

### Preparation of the Permeate (Cycle 1)

516 kg of dry white wine at 11.3 vol. % are subjected to the conditions of step a) as described in example 1 and making it possible to obtain 451 kg of permeate at 9.2 vol. % and 52·4 kg of retentate at 20.5 vol. % This is the permeate which will be used in the rest of the example.

### Preparation of the Permeate (Cycle 2)

514 kg of dry white wine at 11.3 vol. % are subjected to the conditions of step a) as described in example 1 and making it possible to obtain 449.5 kg of permeate at 9.7 vol. % and 64 kg of retentate at 21.7 vol. % This is the retentate which will be used in the rest of the example.

Step (a′): Reduction of the ABV of the Permeate

38.6 kg of permeate at 9.2 vol. % (from step (a) cycle 1) were mixed with 11.2 kg of a metabolised permeate (ABV equal to 0 vol. %) and filtered from a prior dealcoholisation cycle, so as to adjust the degree of alcohol of the mixture to 7.1 vol. %.

Step (b): Removal of Ethanol from the Permeate

The metabolisation of ethanol of this permeate according to step (b3) is carried out under the conditions of Example 6 using a strain 522 Davis (Saccharomyces cerevisiae), marketed by the IOC (Institut CEnologique de Champagne) under the name Harmonie®.

The preculture and culture of these yeasts according to steps (b1), (b2) and (b3), is carried out as described in examples 3 and 4.

43.9 kg of metabolised permeate at 0 vol. % was obtained. After filtration of this metabolised permeate, 38.9 kg of filtered metabolised permeate is obtained.

### Step (c): Diafiltration of the Retentate

A series of diafiltrations of the retentate is then carried out under the conditions of example 7 in order to reduce the ABV of the retentate so as to achieve an ABV value approximately equal to 4 vol. %.

In order to do this, 64 kg of retentate obtained at the end of step (a) (cycle 2) are diafiltered with 256 kg of filtered metabolised permeate from a prior dealcoholisation cycle, in order to obtain 64 kg of diafiltered retentate at 4.2 vol. % and 256 kg of diafiltered metabolised permeate at 5.3 vol. %.

### Step (d) Combining 2 Fractions

A dealcoholised wine having an ABV of approximately 0.5 vol. % is obtained according to step (d) on reconstituting by mixing volumes of these two fractions in order to obtain the desired ABV, i.e. 4.98 kg of diafiltered retentate and 33.98 kg of metabolised permeate at 0 vol. % After homogenisation and filtration, 35.21 kg of dealcoholised wine at 0.5 vol. % were obtained.

Chromatographic analyses (HPLC on an apparatus marketed by Biorad) were carried out in order to know the contents of sugars, organic acids, alcohols and amino acids of the various fractions obtained during the method of the invention.

ICP-MS analyses were carried out in order to know the contents of mineral elements (Li, B, NA, Mg, Al, K, Ca, Sc, V, Cr, Mn, Fe, Co, Ni, Cu, Zn, As, Rb, Sr, Mo, Cd, Sb, Ba, Pb). The results are presented in FIG. 8B.

Finally, semi-quantitative analyses of volatile and semi-volatile organic compounds were carried out by SBSE-GC and TOF-MS: the results are presented in FIG. 8C. In order to obtain this graphic, each compound was assayed semi-quantitatively (results in equivalent concentration of 3-octanol in μg/L). The molecules assayed were grouped together according to the flavour note that characterises them, and their concentrations were added. The concentration of each flavour family is thus evaluated. The presentation of the results in decimal log (logo) enables significant differences in concentrations to be highlighted.

The various intermediate fractions, as well as the initial wine and the dealcoholised wine obtained, were analysed. Remember:
The initial wine; this is a dry white wine, having an ABV equal to 11.3 vol. %, from a blend of base wines and intended for the prise de mousse,
The retentate having an ABV of 21.7 vol. %, from step (a),
The diafiltered retentate having an ABV equal to 4.2 vol. %, from diafiltration step (c),
The permeate having an ABV of 9.2 vol. %, obtained at the end of step (a),
The metabolised permeate having an ABV of 0 vol. %, from step (b),
The filtered metabolised permeate having an ABV of 0 vol. %, and
The dealcoholised wine having an ABV equal to 0.5 vol. %

The results are presented in Table 7 (sugars, organic acids, alcohol) and 8 (particular amino acids) below. The numbers between parentheses indicate the proportion of the component relative to its measured quantity in the initial wine. FIG. 8A illustrates the results from Table 7.

TABLE 7

| | | | | | | | | | | | | | De- | |
|---|---|---|---|---|---|---|---|---|---|---|---|---|---|---|
| | | | | | | | | | | | Filtered | | alcoholised | |
| | Initial | | | | Diafiltered | | | | Metabolised | | metabolised | | wine | |
| Material | wine | | Retentate | | retentate | | Permeate | | permeate | | permeate | | 0-029 | |
| Density at | 0.9889 | | | | 1.0233 | | 0.9859 | | 1.0036 | | 0.9979 | | 1.0008 | |
| 20° C. | | | | | | | | | | | | | | |
| g/cm³ | | | | | | | | | | | | | | |
| ABV vol. % | 11.3 | (1.00) | 21.7 | (1.90) | 4.2 | (0.37) | 9.2 | (0.80) | 0.0 | (0.00) | 0.0 | (0.00) | 0.5 | (0.04) |
| (fraction) | | | | | | | | | | | | | | |
| Glucose g/L | 0.173 | (1.0) | 0.822 | (4.7) | 0.857 | (4.9) | 0.009 | (0.05) | 0.000 | (0.0) | 0.000 | (0.0) | 0.147 | (0.8) |
| (fraction) | | | | | | | | | | | | | | |
| Fructose | 0.437 | (1.0) | 2.615 | (6.0) | 2.939 | (6.73) | 0.008 | (0.02) | 0.000 | (0.0) | 0.000 | (0.0) | 0.359 | (0.82) |
| g/L | | | | | | | | | | | | | | |
| (fraction) | | | | | | | | | | | | | | |
| Glycerol | 4.909 | (1.0) | 27.751 | (5.7) | 28.824 | (5.9) | 0.350 | (0.1) | 1.041 | (0.2) | 0.0061 | (0.0) | 3.540 | (0.7) |
| g/L | | | | | | | | | | | | | | |
| (fraction) | | | | | | | | | | | | | | |
| Lactic | 2.820 | (1.0) | 15.956 | (5.7) | 15.585 | (5.5) | 0.380 | (0.1) | 0.005 | (0.0) | 0.001 | (0.0) | 1.898 | (0.7) |
| acid g/L | | | | | | | | | | | | | | |
| (fraction) | | | | | | | | | | | | | | |
| Malic acid | 0.007 | (1.0) | 0.133 | (18.7) | 0.041 | (5.8) | 0.000 | (0.0) | 1.434 | (202.0) | 0.000 | (0.0) | 0.006 | (0.8) |
| g/L | | | | | | | | | | | | | | |
| (fraction) | | | | | | | | | | | | | | |
| Tartaric | 2.810 | (1.0) | 11.883 | (4.2) | 11.779 | (4.2) | 0.052 | (0.02) | 0.029 | (0.0) | 0.001 | (0.0) | 1.446 | (0.5) |
| acid g/L | | | | | | | | | | | | | | |
| (fraction) | | | | | | | | | | | | | | |
| Acetic | 0.154 | (1.0) | 0.308 | (2.0) | 0.088 | (0.6) | 0.116 | (0.8) | 0.000 | (0.0) | 0.002 | (0.0) | 0.012 | (0.1) |
| acid g/L | | | | | | | | | | | | | | |
| (fraction) | | | | | | | | | | | | | | |
| Succinic | 0.280 | (1.0) | 1.696 | (6.1) | 1.689 | (6.0) | 0.032 | (0.1) | 11.526 | (41.1) | 0.035 | (0.1) | 0.218 | (0.8) |
| acid g/L | | | | | | | | | | | | | | |
| (fraction) | | | | | | | | | | | | | | |
| Citric acid | 0.221 | (1.0) | 2.200 | (10.0) | 1.787 | (8.1) | 0.003 | (0.01) | 0.367 | (1.7) | 0.000 | (0.0) | 0.194 | (0.9) |
| g/L | | | | | | | | | | | | | | |
| (fraction) | | | | | | | | | | | | | | |
| Shikimic | 0.016 | (1.0) | 0.098 | (6.2) | 0.097 | (6.2) | 0.0003 | (0.02) | 0.002 | (0.1) | 0.000 | (0.0) | 0.013 | (0.8) |
| acid g/L | | | | | | | | | | | | | | |
| (fraction) | | | | | | | | | | | | | | |
| Isovaleric | 0.019 | (1.0) | 0.083 | (4.4) | 0.022 | (1.2) | 0.000 | (0.0) | 0.111 | (6.0) | 0.000 | (0.0) | 0.035 | (1.9) |

| and | | | | | | | | | | | | |
|---|---|---|---|---|---|---|---|---|---|---|---|---|
| pyruvic | | | | | | | | | | | | |
| acids g/L | | | | | | | | | | | | |
| (fraction) | | | | | | | | | | | | |
| Total | 717 | (1.0) | ND* | 906 | (1.3) | ND* | 0 | (0.0) | 0 | (0.0) | 510 | (0.7) |

amino
acids
mg/L
(fraction)

*Not defined

TABLE 8

| | | | | Filtered | Dealco- |
|---|---|---|---|---|---|
| Amino | Initial | Diafiltered | Metabolised | metabolised | holised |
| acid | wine | retentate | permeate | permeate | wine 0-029 |
| Proline mg/L | 170.12 | 208.8 | 0.00 | 0.00 | 217.45 |
| (fraction)* | (1.00) | (1.23) | (0.00) | (0.00) | (1.28) |
| Gamma- | 61.12 | 60.02 | 0.00 | 0.00 | 35.06 |
| aminobutyric | (1.00) | (0.98) | (0.00) | (0.00) | (0.57) |
| acid mg/L | | | | | |
| (fraction) | | | | | |
| Asparagine | 32.39 | 48.97 | 0.00 | 0.00 | 18.52 |
| mg/L | (1.00) | (1.51) | (0.00) | (0.00) | (0.57) |
| (fraction) | | | | | |
| Ornithine | 36.72 | 48.60 | 0.00 | 0.00 | 20.83 |
| mg/L | (1.00) | (1.32) | (0.00) | (0.00) | (0.57) |
| (fraction) | | | | | |
| Alanine | 47.12 | 59.56 | 0.00 | 0.00 | 26.18 |
| mg/L | (1.00) | (1.26) | (0.00) | (0.00) | (0.56) |
| (fraction) | | | | | |
| Glycine | 17.76 | 24.24 | 0.00 | 0.00 | 10.03 |
| mg/L | (1.00) | (1.36) | (0.00) | (0.00) | (0.56) |
| (fraction) | | | | | |
| Lysine mg/L | 59.25 | 66.66 | 0.00 | 0.00 | 32.54 |
| (fraction) | (1.00) | (1.13) | (0.00) | (0.00) | (0.55) |
| Glutamate | 46.92 | 58.01 | 0.00 | 0.00 | 25.5 |
| mg/L | (1.00) | (1.24) | (0.00) | (0.00) | (0.54) |
| (fraction) | | | | | |
| Phenylalanine | 27.33 | 44.23 | 0.00 | 0.00 | 14.84 |
| mg/L | (1.00) | (1.62) | (0.00) | (0.00) | (0.54) |
| (fraction) | | | | | |
| Serine mg/L | 14.43 | 21.45 | 0.00 | 0.00 | 7.76 |
| (fraction) | (1.00) | (1.49) | (0.00) | (0.00) | (0.54) |
| Arginine | 40.71 | 70.37 | 0.00 | 0.00 | 21.76 |
| mg/L | (1.00) | (1.73) | (0.00) | (0.00) | (0.53) |
| (fraction) | | | | | |
| Leucine | 43.09 | 14.00 | 0.00 | 0.00 | 23.03 |
| mg/L | (1.00) | (0.32) | (0.00) | (0.00) | (0.53) |
| (fraction) | | | | | |
| Valine mg/L | 14.37 | 21.24 | 0.00 | 0.00 | 7.60 |
| (fraction) | (1.00) | (1.48) | (0.00) | (0.00) | (0.53) |
| Methionine | 6.33 | 10.22 | 0.00 | 0.00 | 3.29 |
| mg/L | (1.00) | (1.61) | (0.00) | (0.00) | (0.52) |
| (fraction) | | | | | |
| Threonine | 11.42 | 17 | 0.00 | 0.00 | 5.93 |
| mg/L | (1.00) | (1.49) | (0.00) | (0.00) | (0.52) |
| (fraction) | | | | | |
| Tyrosine | 21.07 | 31.94 | 0.00 | 0.00 | 10.95 |
| mg/L | (1.00) | (1.52) | (0.00) | (0.00) | (0.52) |
| (fraction) | | | | | |
| Histidine | 13.31 | 22.17 | 0.00 | 0.00 | 6.85 |
| mg/L | (1.00) | (1.67) | (0.00) | (0.00) | (0.51) |
| (fraction) | | | | | |
| Isoleucine | 9.01 | 32.84 | 0.00 | 0.00 | 4.41 |
| mg/L | (1.00) | (3.64) | (0.00) | (0.00) | (0.49) |
| (fraction) | | | | | |
| Aspartate | 34.04 | 35.87 | 0.00 | 0.00 | 15.38 |
| mg/L | (1.00) | (1.05) | (0.00) | (0.00) | (0.45) |
| (fraction) | | | | | |
| Citrulline | 5.75 | 7.61 | 0.00 | 0.00 | 2.15 |
| mg/L | (1.00) | (1.32) | (0.00) | (0.00) | (0.37) |
| (fraction) | | | | | |
| Cysteine | 0.86 | 0.00 | 0.00 | 0.00 | 0.00 |
| mg/L | (1.00) | (0.00) | (0.00) | (0.00) | (0.00) |
| (fraction) | | | | | |
| Tryptophan | 3.39 | 1.02 | 0.00 | 0.00 | 0.00 |
| mg/L | (1.00) | (0.30) | (0.00) | (0.00) | (0.00) |
| (fraction) | | | | | |
| Total | 716.5 | 905.8 | 0.00 | 0.00 | 510.10 |
| | (1.00) | (1.26) | (0.00) | (0.00) | (0.71) |

With regards to the compounds of interest, in other words the compounds having an organoleptic impact, the reconstituted wine has conserved, compared to the initial wine, approximately 80% of the sugars, 70% of the glycerol and of the lactic acid, 80% of the malic acid but only 50% of the tartaric acid.

The dealcoholised wine has also conserved 80 to 90% of the fermentation organic acids (citric, succinic and shikimic acids), but only 10% of the acetic acid, which can be considered as a small improvement in quality.

By contrast, the concentration of isovaleric and pyruvic acids has doubled in the dealcoholised wine, but this is not perceived as a defect during the tasting of the dealcoholised wine.

The reconstituted wine has conserved only 70% of the amino acids relative to the initial wine (see Tables 7 and 8).

With regard to each amino acid (alanine, arginine, asparagine, aspartate, glutamate, glutamine, glycine, histidine, leucine, lysine, phenylalanine, serine, threonine, tyrosine, valine and gamma-aminobutyric acid), for each there has been a reduction in the quantity in the reconstituted wine, except for proline, the amino acid with the highest concentration (170 mg/L) in the initial wine, which is present in the reconstituted wine at 128% of its original concentration. Finally, the amino acids tryptophan (at 3.4 mg/L) and cysteine (at 0.9 mg/L) are absent in the reconstituted wine, and isoleucine is conserved at 49% of its concentration in the initial wine.

With regard to the compounds that are undesirable from a flavour point of view, the dealcoholised wine has concentrations less than those of the initial wine for the following compounds:
The ethyl acetate component (solvent odour) has a concentration of 13.7 mg/L in the initial wine, but it is absent in the dealcoholised wine (0 mg/L);
2-methyl-1-propanol (isobutanol, green vegetal flavour) is present at 13 mg/L in the initial wine, but only at a concentration equal to 68% of this value (8.8 mg/L) in the dealcoholised wine;
ethyl lactate (milky flavour) is present at a concentration of 59.6 mg/L in the initial wine, but only at a concentration equal to 31% of this value in the dealcoholised wine (18.7 mg/L).

With regard to the mineral elements, the distributions of the compounds in the initial wine and in the dealcoholised reconstituted wine are very close, as illustrated in FIG. 8B. The respective proportion of each compound is conserved throughout the process.

As illustrated in FIG. 8C, the flavour profile of the dealcoholised wine is very close, almost able to be superimposed, to that of the original wine.

It is clear on the graphic thus obtained that the respective proportion of each flavour family is conserved during the dealcoholisation method.

A blind tasting by a panel of knowledgeable professional tasters was able to carry out a sensory analysis (the result of which is transcribed in free text in order to take account of the feelings of the tasters) of the initial wine and of the dealcoholised wine once blended, in order to compare them.

The results are presented in table 9 below.

TABLE 9

| | Initial wine | Dealcoholised wine | Comments |
|---|---|---|---|
| Without | Pale golden yellow | Pale yellow colour | The colour appears |
| CO₂ | colour | Crisp white fruits | slightly modified (less |
| | Crisp white fruits (apple, | (apple, pear) | bright, less golden) |
| | green apple, pear) | Freshness, citrus | and the flavour |
| | Freshness, citrus | Acidic, citric | appears a little less |
| | Acidic, citric | | complex. |
| With | Pale golden yellow | Pale yellow colour | Same for the colour |
| CO₂ | colour | Crisp white fruits | Same for the flavour |
| | Crisp white fruits (apple, | (green apple), rhubarb | complexity |
| | green apple, pear) | Freshness, citrus | The effervescence |
| | Freshness, citrus | Empyreumatic notes | enhances the |
| | Empyreumatic notes | (bread crusts, etc.) | perceptions in the |
| | (toasted bread, etc.) | Acidic, citric | mouth (bitterness, |
| | Acidic, citric | | acidity). These |
| | More intense bitterness | | features are less |
| | More complex acidity | | complex in the |
| | | | dealcoholised wine. |

This sensory analysis makes it possible to conclude that the alcoholic or dealcoholised wines have a similar profile and that the proximity of their flavour profiles demonstrates good preservation of the compounds of interest and more particularly of the flavour compounds using the method according to the invention.

### Example 10. Complete Method for Total Dealcoholisation of a Rose Wine and Characterisation of the Initial Rose Wine and of the Dealcoholised Rose Wine, Using Physicochemical Parameters

All the fractions produced and used in this example (permeate, filtered permeate, retentate, diafiltered retentate, etc.) are from a single batch of rose wine, but from several different cycles.

The values indicated in this example are approximations to one decimal place of the effectively measured values, except in the tables.

### Step (a): Preparation of the Permeates and Retentates

### Cycle 1

136 kg of rose wine at 10.9 vol. % are subjected to the conditions of step (a) as described in example 1 and making it possible to obtain 119 kg of permeate at 8.6 vol. % and 11.35 kg of retentate at 21.8 vol. %.

### Cycle 2

136 kg of rose wine at 11 vol. % are subjected to the conditions of step (a) as described in example 1 and making it possible to obtain 119 kg of permeate at 8.5 vol. % and 11.9 kg of retentate at 21.9 vol. %.

Step (a′): Reduction of the ABV of the Permeates

1.101 kg of permeate at 7.82 vol. % (from step (a) cycle 1) were mixed with 0.28590 kg of a metabolised permeate (ABV equal to 0 vol. %) and filtered from a prior dealcoholisation cycle, so as to adjust the degree of alcohol of the mixture to 6.25 vol. %.

Step (b): Removal of Ethanol from the Permeates

The metabolisation of the ethanol of this permeate according to step (b3) is carried out under the conditions of example 6 using a strain of Saccharomyces cerevisiae, marketed by IOC under the name IOC20070.

The preculture and culture of these yeasts according to steps (b1), (b2) and (b3), is carried out as described in examples 3 and 4.

0.850 kg of metabolised permeate at 0 vol. % was obtained. After filtration of this metabolised permeate, 0.830 kg of filtered metabolised permeate is obtained.

### Step (c): Diafiltration of the Retentates

The retentates from cycles 1 and 2 are mixed.

A series of diafiltrations of this blend of retentates is then carried out under the conditions of example 7 in order to reduce the ABV of the retentate so as to achieve an ABV value approximately equal to 4 vol. %.

In order to do this, 17.35 kg of retentate obtained at the end of step (a) (cycles 1 and 2) are diafiltered with 69.4 kg of filtered metabolised permeate from a prior dealcoholisation cycle, in order to obtain 14.35 kg of diafiltered retentate at 3.8 vol. % and 69.4 kg of diafiltered metabolised permeate at 4.8 vol. %.

Step (d) Combining 2 Fractions from Rosé Wine

A dealcoholised wine having an ABV of approximately 0.5 vol. % is obtained according to step (d) on reconstituting by mixing volumes of these two fractions in order to obtain the desired ABV, i.e. 0.025 kg of diafiltered retentate and 0.175 kg of metabolised permeate at 0 vol. % After homogenisation and filtration, 0.2 kg of dealcoholised wine at 0.5 vol. % were obtained.

Chromatographic analyses (HPLC on an apparatus marketed by Biorad) were carried out in order to know the contents of sugars, organic acids and alcohols.

Semi-quantitative analyses of volatile and semi-volatile organic compounds were carried out by SBSE-GC and TOF-MS.

ICP-MS analyses were carried out in order to know the contents of mineral elements (Li, B, NA, Mg, Al, K, Ca, Sc, V, Cr, Mn, Fe, Co, Ni, Cu, Zn, As, Rb, Sr, Mo, Cd, Sb, Ba, Pb).

The initial wine and the dealcoholised wine obtained, were analysed. Remember:
The initial wine; this is a rose wine, having an ABV equal to 10.9 vol. %, from a blend of base wines and intended for the prise de mousse,
The dealcoholised wine having an ABV equal to 0.5 vol. %

The results are presented in Table 10 below and FIG. 9A (sugars, organic acids, alcohol) and in FIGS. 9B (average mineral load) and 9C (flavour profiles). In the table below, the numbers between parentheses indicate the proportion of the component relative to its measured quantity in the initial wine.

TABLE 10
(sugars, organic acids, alcohols)

| | Initial | Dealcoholised |
|---|---|---|
| Material | rosé wine | rosé wine |
| ABV vol. % | 10.9 | 0.55 |
| (Fraction) | (1) | (0.05) |
| Citric acid g/L | 0.45 | 0.1 |
| (Fraction) | (1) | (0.65) |
| L-malic acid g/L | 1.98 | 1.02 |
| (Fraction) | (1) | (0.51) |
| Glucose g/L | 0.28 | 0.21 |
| (Fraction) | (1) | (0.74) |
| Fructose g/L | 0.61 | 0.44 |
| (Fraction) | (1) | (0.72) |
| Succinic acid g/L | 1.44 | 0.94 |
| (Fraction) | (1) | (0.65) |
| Shikimic acid g/L | 0.02 | 0.02 |
| (Fraction) | (1) | (0.74) |
| Fumaric acid g/L | 0.00 | 0.00 |
| (Fraction) | (1) | (0.6) |
| Lactic acid g/L | 1.98 | 1.22 |
| (Fraction) | (1) | (0.62) |
| Glycerol g/L | 5.08 | 3.47 |
| (Fraction) | (1) | (0.68) |
| Acetic acid g/L | 0.16 | 0.04 |
| (Fraction) | (1) | (0.26) |
| Propanoic acid g/L | 0.07 | 0.05 |
| (Fraction) | (1) | (0.72) |
| Ethanol g/L | 85.89 | 4.32 |
| (Fraction) | (1) | (0.05) |

With regards to the compounds of interest, in other words the compounds having an organoleptic impact, the reconstituted wine has conserved, compared to the initial wine, approximately 73% of the sugars, 68% of the glycerol and 62% of the lactic acid, 51% of the malic acid.

The dealcoholised wine has also conserved 70% of the fermentation organic acids (citric, succinic and shikimic acids), but only 26% of the acetic acid, which can be considered an improvement in quality.

With regard to the mineral elements (FIG. 9B), the distributions of the compounds in the initial wine and in the dealcoholised reconstituted wine are very close. The respective proportion of each compound is conserved throughout the process even if the average mineral load of the dealcoholised reconstituted wine is lower (71%) than that of the initial wine.

FIG. 9C shows, for the 2 fractions analysed (initial rose wine and dealcoholised rose wine), the distribution of the flavour contributions relative to the total of each fraction. The profile of the dealcoholised wine is very close (almost able to be superimposed), to that of the original wine. The respective proportion of each flavour family is conserved throughout the method.

### Example 11. Complete Method for Total Dealcoholisation of a Red Wine Obtained by Maceration

All the fractions produced and used in this example (permeate, filtered permeate, retentate, diafiltered, retentate, etc.) are from a single batch of wine, but from several different cycles.

A red wine obtained by maceration corresponds to a wine treated according to a vinification process which consists in, after crushing of black grapes, leaving the must in contact with the solid parts of the grapes (skins, pulp and seeds) during vatting in order to extract the colour, tannins and the flavours contained in these solid elements. The alcohol fermentation, through the increase in the content of ethanol and the temperature, promotes this extraction.

### Step (a): Preparation of the Permeates and Retentates

### Cycle 1

136 kg of red wine by maceration at 11.7 vol. % are subjected to the conditions of step (a) as described in example 1 and making it possible to obtain 119 kg of permeate at 10.2 vol. % and 12.7 kg of retentate at 20.3 vol. %.

### Cycle 2

117.3 kg of red wine by maceration at 11.9 vol. % are subjected to the conditions of step (a) as described in example 1 and making it possible to obtain 102.6 kg of permeate at 9.9 vol. % and 10.5 kg of retentate at 21.8 vol. %.

Step (a′): Reduction of the ABV of the Permeate

0.77620 kg of the permeate at 11.05 vol. % (from step (a) cycle 1) were mixed with 0.61050 kg of a filtered metabolised permeate (ABV equal to 0 vol. %) from a prior dealcoholisation cycle, so as to adjust the degree of alcohol of the mixture to 6.22 vol. %.

Step (b): Removal of Ethanol from the Permeates

The metabolisation of ethanol of this permeate according to step (b3) is carried out under the conditions of example 6 using a strain of Saccharomyces cerevisiae, marketed by IOC under the name IOC18-20070.

The preculture and culture of these yeasts according to steps (b1), (b2) and (b3), is carried out as described in examples 3 and 4.

0.8 kg of metabolised permeate at 0 vol. % was obtained. After filtration of this metabolised permeate, 0.780 kg of filtered metabolised permeate is obtained.

### Step (c): Diafiltration of the Retentates

The retentates from cycles 1 and 2 are mixed.

A series of diafiltrations of this blend of retentates is then carried out under the conditions of example 7 in order to reduce the ABV of the retentate so as to achieve an ABV value approximately equal to 4 vol. %.

In order to do this, 15.55 kg of retentate obtained at the end of step (a) (cycles 1 and 2) are diafiltered with 62.2 kg of filtered metabolised permeate from a prior dealcoholisation cycle, in order to obtain 12.65 kg of diafiltered retentate at 3.3 vol. % and 62·2 kg of diafiltered metabolised permeate at 3.8 vol. %.

### Example 12. Complete Method for Total Dealcoholisation of a Red Wine Obtained by Thermovinification

A red wine obtained by thermovinification corresponds to a wine obtained according to a vinification process which consists of rapidly heating the crushed black grapes (from 60 to 80° C.) for several minutes, then conducting a hot maceration for several hours (1 to 2 hours), before cooling the must and separating the solid parts from the liquid phase (by pressing, filtration, decantation, etc.) and carrying out the vinification in the liquid phase. The aim is to extract the colour, tannins and flavours of the grape very rapidly.

### Step (a): Preparation of the Permeate and the Retentate

136 kg of red wine by thermovinification at 11 vol. % are subjected to the conditions of step (a) as described in example 1 and making it possible to obtain 119 kg of permeate at 8.5 vol. % and 11.35 kg of retentate at 19 vol. %.

Step (a′): Reduction of the ABV of the Permeates

0.880 kg of the permeate at 10.1 vol. % (from step (a) cycle 1) were mixed with 0.53740 kg of a filtered metabolised permeate (ABV equal to 0 vol. %) from a prior dealcoholisation cycle, so as to adjust the degree of alcohol of the mixture to 6.21 vol. %.

Step (b): Removal of Ethanol from the Permeates

The metabolisation of the ethanol of this permeate according to step (b3) is carried out under the conditions of example 6 using a strain of Saccharomyces cerevisiae, marketed by IOC under the name IOC18-20070.

The preculture and culture of these yeasts according to steps (b1), (b2) and (b3), is carried out as described in examples 3 and 4.

0.8 kg of metabolised permeate at 0 vol. % was obtained. After filtration of this metabolised permeate, 0.78 kg of filtered metabolised permeate is obtained.

### Example 13. Physical Separation by Reverse Osmosis of a Sweet White Wine (40 g/l Sugars) into Two Fractions, Permeate 1 and Retentate 1 (Step a)

The equipment for reverse osmosis substantially consists of a high-pressure pump that can deliver up to 60 bars, and a 2.5-inch diameter reverse osmosis membrane (Reference: Alfa Laval RO98pHt). 26 m² of membrane were installed.

An equipment diagram is shown in FIG. 3.

The wine used in this example is a sweet white wine, containing 40 g/L of residual sugars, having an ABV value equal to 11.5 vol. %. 132 kg of wine are introduced into the feed tank (1), that has been inerted beforehand. The tank is then hermetically closed, a tank head containing less than 2% 02 is maintained by successive additions of nitrogen via the regulator (3).

The feed device is then hydraulically connected to the reverse osmosis device (RO, central rectangle), and the wine is pumped to the RO equipment by means of the centrifugal pump (10) of the feed device. Then, the positive displacement pump (15) of the RO device is switched on in order to make the wine circulate in the vicinity of the membrane (16), the portion of wine leaving the RO device returning to the feed tank via the strainer (12), the mass flow meter (11) and the plate exchanger (7). The strainer (12) can retain the scale crystals appearing due to the concentration. The mass flow meter (11) can read the flow rate and also the density, thus monitoring the concentration throughout the process. The exchanger (7) can dissipate the energy contributed by the positive displacement pump (15) and thus regulate the temperature at approximately 15° C. for the retentate loop. The pressure is obtained by gradually closing the pressure valve (17), typically until obtaining a pressure of approximately 50 bars at the inlet of the membrane.

In this example, the separation is performed at a pressure of approximately 50 bars, continuously maintained on the retentate side. The operation is continued until attaining a VCF (volume concentration factor) of k=3.4.

The flow rate (L/h/m2) applied to the membrane gradually reduces the flow of the permeate. The quantity of ethanol by mass passing into the permeate is measured instantaneously over time, using a density meter. The ethanol/permeate titre (vol. %) is calculated from the mass percentage of ethanol, taking into account the density of ethanol (789 g/L) in other words by dividing the mass percentage of ethanol by 0.789.

Table 11 below presents the measurements obtained during a test with an ALFA LAVAL RO98pHt membrane used in a reverse osmosis method applied to a sweet white wine.

TABLE 11
Physical separation of a sweet white wine by reverse osmosis

| | | Ethanol/ | Ethanol/ | | |
|---|---|---|---|---|---|
| Time | Permeate | permeate | permeate | VCF | Flow rate |
| (min) | (kg) | titre (% v/v) | titre (% v/v) | (k) | (L/h/m²) |
| 0 | | | | | |
| 15 | 1.8 | 5.1 | 4.0 | 1.01 | 2.3 |
| 60 | 8.6 | 5.8 | 4.6 | 1.07 | 1.1 |
| 120 | 16.8 | 6.3 | 5.0 | 1.14 | 1.0 |
| 160 | 21.6 | 6.6 | 5.2 | 1.19 | 0.9 |
| 240 | 30.2 | 7.0 | 5.6 | 1.29 | 0.8 |
| 300 | 36 | 7.5 | 5.9 | 1.36 | 0.7 |
| 330 | 38.6 | 7.7 | 6.1 | 1.40 | 0.7 |
| 360 | 41.2 | 7.9 | 6.2 | 1.43 | 0.7 |
| 405 | 44.8 | 8.2 | 6.5 | 1.49 | 0.6 |
| 450 | 48.2 | 8.5 | 6.7 | 1.55 | 0.6 |
| 485 | 51 | 8.7 | 6.9 | 1.60 | 0.6 |
| 510 | 52.6 | 9.0 | 7.1 | 1.63 | 0.5 |
| 570 | 56.2 | 9.3 | 7.3 | 1.70 | 0.5 |
| 645 | 60.4 | 9.8 | 7.7 | 1.80 | 0.4 |
| 690 | 62.6 | 9.9 | 7.8 | 1.85 | 0.4 |
| 780 | 66.8 | 10.5 | 8.3 | 1.97 | 0.4 |
| 840 | 68.4 | 10.8 | 8.6 | 2.01 | 0.2 |
| 910 | 71.2 | 11.2 | 8.8 | 2.10 | 0.3 |
| 973 | 74.6 | 11.5 | 9.0 | 2.21 | 0.4 |
| 1030 | 76.2 | 11.4 | 9.0 | 2.27 | 0.2 |
| 1110 | 78.8 | 11.9 | 9.4 | 2.38 | 0.2 |
| 1200 | 81.4 | 12.3 | 9.7 | 2.49 | 0.2 |
| 1295 | 83.8 | 12.7 | 10.1 | 2.61 | 0.2 |
| 1350 | 85.2 | 12.9 | 10.2 | 2.68 | 0.2 |
| 1410 | 86.6 | 13.2 | 10.4 | 2.75 | 0.2 |
| 1482 | 88.2 | 13.3 | 10.5 | 2.85 | 0.2 |
| 1540 | 89.2 | 12.4 | 9.8 | 2.91 | 0.1 |
| 1602 | 90.4 | 12.9 | 10.2 | 2.98 | 0.1 |
| 1662 | 91.4 | 13.2 | 10.4 | 3.05 | 0.1 |
| 1702 | 92 | 13.4 | 10.6 | 3.09 | 0.1 |
| 1842 | 94 | 13.6 | 10.8 | 3.24 | 0.1 |
| 1922 | 95 | 13.4 | 10.5 | 3.32 | 0.1 |
| 1977 | 95.8 | 13.6 | 10.7 | 3.38 | 0.1 |

Thus 36 kg of retentate and 96 kg of permeate are obtained.

The ABV of the permeate is measured instantaneously during its flow, and therefore does not reflect the final ABV of the final homogenised permeate, which is 10 vol. % It is observed, however, that over time, the ABV of the permeate which flows increases.

### BIBLIOGRAPHICAL REFERENCES

FR2852493A1
FR2887258B1
US2016/348192A1
WO 2015/114115
U.S. Pat. No. 5,266,337
EP3550007
WO 2011/088809
WO 90/01537
Morales P, Rojas V, Quirós M, Gonzalez R. The impact of oxygen on the final alcohol content of wine fermented by a mixed starter culture. Appl Microbiol Biotechnol. 2015 May; 99(9): 3993-4003. doi: 10.1007/s00253-014-6321-3.
Gary J. Pickering (2000) Low- and Reduced-alcohol Wine: A Review. Journal of Wine Research, 11, 129-144.
Varela, C., Dry, P., Kutyna, D., Francis, I., Henschke, P., Curtin, C. and Chambers, P. (2015), Reducing alcohol concentration in wine. Australian Journal of Grape and Wine Research, 21, 670-679.
Thomas Ochando, Jean-Roch Mouret, Anne Humbert-Goffard, Jean-Marie Sablayrolles, Vincent Farines (2017). Impact of initial lipid content and oxygen supply on alcoholic fermentation in champagne-like musts. Food Research International, 98, 87-94.
Barnett, J. A., Payne, R. W., E& Yarrow, D. (1990). Yeast identification program, version 2. Cambridge: Cambridge University Press. Buchanan R E, Gibbono N E (1974) Bergey's Manual of Determinative Bacteriology. Baltimore, MD: Williams E& Wilkins.
Bärwald, G. and Fischer, A. (1996) Crabtree effect in aerobic fermentations using grape juice for the production of alcohol reduced wine. Biotechnology Letters 18, 1187-1192.
Box C E P, Hunter W G, Hunter J S (1978) Statistics for Experimenters. New York: Wiley, 6, 33-34.
Ishmayana, S., Kennedy, U. J., E& Learmonth, R. P. (2015). Preliminary evidence of inositol supplementation effect on cell growth, viability and plasma membrane fluidity of the yeast Saccharomyces cerevisiae. Procedia Chemistry, 17, 162-169.
Ishmayana, S., Kennedy, U. J., & Learmonth, R. P. (2020) The effect of varying inositol supplementation on Saccharomyces cerevisiae grown in chemically defined media. Octa J. Bioscience. Vol 8, 98-105.
Rodrigues, A. J., Raimbourg, T., Gonzalez, R. and Morales, P. (2016) Environmental factors influencing the efficacy of different yeast strains for alcohol level reduction in wine by respiration. LWT—Food Science and Technology, 65,1038-1043.

1. A method for dealcoholisation of a volume V1 of a wine having a percentage of alcohol by volume (ABV) of value ABV(1), comprising the following steps:
a) separating the volume V1 of the wine into two fractions using a membrane separation method:
one fraction concentrated by a factor k referred to as “retentate”, the volume of this fraction being equal to 1/k V1, this fraction having a value ABV(R);
one fraction referred to as “permeate” comprising predominantly water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the resulting fraction being referred to as “metabolised permeate” having a value ABV(P metabolised) less than ABV(P);
c) optionally, diafiltrating the retentate with the metabolised permeate, in order to obtain:
a “diafiltered retentate” having a value ABV(R diafiltered) less than ABV(R), and
a “diafiltered metabolised permeate” having an ABV value greater than ABV(P metabolised), said diafiltered metabolised permeate then being optionally subjected again to step (b);
d) combining a volume of retentate or of diafiltered retentate and a volume of metabolised permeate, in order to obtain a volume V2 of dealcoholised wine, having a value ABV(2) less than ABV(1).

2. The method according to claim 1, wherein the concentration factor k is 0.1 to 20.

3. The method according to claim 1, wherein step (a) is carried out by reverse osmosis or by nanofiltration.

4. The method according to claim 1, wherein step (a) is carried out by reverse osmosis with a membrane having a rejection rate for salts greater than 0.9.

5. The method according to claim 1, wherein step (a) is carried out at a temperature between 15° C. and 25° C.

6. The method according to claim 1, wherein step (a) is carried under an atmosphere mainly composed of inert gas and comprising less than 1% dioxygen.

7. The method according to claim 1, wherein the permeate is subjected to at least one step (a′) of reducing its ABV(P), carried out by evaporation, distillation, dilution or membrane contractor.

8. The method according to claim 1, wherein step (b) comprises three substeps:
b1) pre-culturing of at least 10⁶ yeasts per millilitre, in a growth medium comprising a source of sugar at a concentration between 40 and 120 g/kg, under aerobic conditions,
b2) culturing at least 10⁶ yeasts resulting from step (b1) per millilitre, in a growth medium comprising a source of sugar at a concentration between 40 and 120 g/kg, under aerobic conditions, the volume of culture being identical to the volume of permeate to be treated in the following substep,
b3) adding at least 2·10⁸ yeasts per millilitre to the permeate to be treated, and metabolisation of the ethanol by the yeasts under aerobic conditions.

9. The method according to claim 8, wherein step (b3) of metabolisation of the ethanol by yeasts in respiratory state is carried out under a flow of dioxygen from 0.001 to 0.010 volume per volume per minute (vvm).

10. The method according to claim 1, wherein the yeasts added to the permeate in step (b) are of the genus Saccharomyces.

11. A metabolised permeate obtained by a method comprising the following steps:
a) separating the volume V1 of a wine into two fractions using a membrane separation method:
one fraction concentrated by a factor k referred to as “retentate”, the volume of this fraction being equal to 1/k V1, this fraction having a value of ABV(R);
one fraction referred to as “permeate” comprising predominantly water and ethanol, the volume of this fraction being equal to (k−1)/k V1, this fraction having a value of ABV(P);
b) removing the ethanol from the permeate by yeasts added to said permeate, said yeasts being in respiratory state in order to metabolise the ethanol, said metabolised permeate having a value ABV(P metabolised) less than ABV(P).

12. A method for dealcoholisation of a volume V1 of a wine having a percentage of alcohol by volume (ABV) of value ABV(1), comprising the following steps:
a) separating the volume V1 of the wine into two fractions using a membrane separation method:
one fraction concentrated by a factor k referred to as “retentate”, the volume of this fraction being equal to 1/k V1, this fraction having a value ABV(R);
one fraction referred to as “permeate” comprising predominantly water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the resulting fraction being referred to as “metabolised permeate” having a value ABV(P metabolised) less than ABV(P);
c) optionally, diafiltrating the retentate with the metabolised permeate, in order to obtain:
a “diafiltered retentate” having a value ABV(R diafiltered) less than ABV(R), and
a “diafiltered metabolised permeate” having an ABV value greater than ABV(P metabolised), said diafiltered metabolised permeate then being optionally subjected again to step (b);
d) combining a volume of retentate or of diafiltered retentate and a volume of metabolised permeate, in order to obtain a volume V2 of dealcoholised wine, having a value ABV(2) less than ABV(1)
wherein the permeate is subjected to at least one step (a′) of reducing its ABV(P), carried out by evaporation, distillation, dilution or membrane contractor and wherein the dilution agent is the metabolised permeate according to claim 11.

13. The method according to claim 1, comprising the following steps:
a) separating the volume V1 of the wine into two fractions using a membrane separation method:
one fraction concentrated by a factor k referred to as “retentate”, the volume of this fraction being equal to 1/k V1, this fraction having a value ABV(R);
one fraction referred to as “permeate” comprising predominantly water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the resulting fraction being referred to as “metabolised permeate” having a value ABV(P metabolised) less than ABV(P); and
c) combining a volume of retentate and a volume of metabolised permeate, in order to obtain a volume V2 of dealcoholised wine having a value ABV(2) less than ABV(1), and wherein the dealcoholisation of the volume V1 of wine is partial.

14. The method for according to claim 1, comprising the following steps:
a) separating the volume V1 of the wine into two fractions using a membrane separation method:
one fraction concentrated by a factor k referred to as “retentate”, the volume of this fraction being equal to 1/k V1, this fraction having a value ABV(R);
one fraction referred to as “permeate” comprising predominantly water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the resulting fraction being referred to as “metabolised permeate” having a value ABV(P metabolised) less than ABV(P);
c) diafiltrating the retentate with a metabolised permeate having an ABV value equal to 0 vol. %, in order to obtain:
a “diafiltered retentate” having a value ABV(R diafiltered) less than ABV(R), and
a “diafiltered metabolised permeate” having an ABV value greater than ABV(P metabolised), said diafiltered metabolised permeate then being subjected again to step (b) until obtaining an ABV value less than or equal to 0.5 vol. %;
d) combining a volume of diafiltered retentate, and a volume of metabolised permeate having an ABV value less than or equal to 0.5 vol. %, in order to obtain a volume V2 of dealcoholised wine having a value ABV(2) less than or equal to 0.5 vol. %, wherein the dealcoholisation of the volume V1 of wine is total.

15. The method according to claim 1, wherein step (d) of combining the two fractions constituting the volume V2 of dealcoholised wine is carried out according to the following proportions:
the volume of the metabolised permeate is equal to (k−1)/k V2; and
the volume of the retentate or diafiltered retentate is equal to 1/k V2.

16. The method according to claim 1, wherein the wine is a white wine a rosé wine, or a red wine.

17. The method according to claim 2, wherein the concentration factor k is 2 to 10.

18. The method according to claim 2, wherein the concentration factor k is 5 to 10.

19. The method according to claim 4, wherein step (a) is carried out by reverse osmosis with a membrane having a rejection rate for salts greater than 0.95.

20. The method according to claim 9, wherein step (b3) is carried out under a flow of dioxygen of 0.002 to 0.008 vvm.

21. The method according to claim 10, wherein the yeasts added to the permeate in step (b) are of the species Saccharomyces cerevisiae.

22. The metabolised permeate according to claim 11, wherein said metabolised permeate has a value ABV(P metabolised) equal to 0 vol. %.

23. A method for dealcoholisation of a volume V1 of a wine having a percentage of alcohol by volume (ABV) of value ABV(1), comprising the following steps:
a) separating the volume V1 of the wine into two fractions using a membrane separation method:
one fraction concentrated by a factor k referred to as “retentate”, the volume of this fraction being equal to 1/k V1, this fraction having a value ABV(R);
one fraction referred to as “permeate” comprising predominantly water and ethanol, the volume of this fraction being equal to (k−1)/k V1, this fraction having a value ABV(P);
b) removing the ethanol from the permeate by yeasts added to said permeate, said yeasts being in respiratory state in order to metabolise the ethanol, the resulting fraction being referred to as “metabolised permeate” having a value ABV(P metabolised) less than ABV(P);
c) optionally, diafiltrating the retentate with the metabolised permeate, in order to obtain:
a “diafiltered retentate” having a value ABV(R diafiltered) less than ABV(R), and
a “diafiltered metabolised permeate” having an ABV value greater than ABV(P metabolised), said diafiltered metabolised permeate then being optionally subjected again to step (b);
d) combining a volume of retentate or of diafiltered retentate and a volume of metabolised permeate, in order to obtain a volume V2 of dealcoholised wine, having a value ABV(2) less than ABV(1),
wherein in step (c), the diafiltration agent is the metabolised permeate according to claim 11.

24. The method according to claim 14, wherein in step (d), a diafiltered retentate is combined with a metabolised permeate having an ABV value equal to 0 vol. % or with a diafiltered metabolised permeate having an ABV value equal to 0 vol. %.

25. The method according to claim 16, wherein the wine is a still wine or a sparkling wine.

26. The method according to claim 25, wherein the wine is a sparkling wine previously degassed.
